(19) United States
(12) Patent Application Publication
(10) Pub. No.: US 2026/0073259 A1
(43) Pub. Date: Mar. 12, 2026

(54) ARTIFICIAL INTELLIGENCE DEVICE FOR LANGUAGE-BASED EFFICIENT AGENT UTILIZATION FOR NAVIGATION (LEAN) AND METHOD THEREOF

(71) Applicant: LG ELECTRONICS INC., Seoul (KR)

(72) Inventors: Nikhil VERMA, Toronto (CA); Manasa BHARADWAJ, Toronto (CA)

(73) Assignee: LG ELECTRONICS INC., Seoul (KR)

(21) Appl. No.: 19/319,481

(22) Filed: Sep. 4, 2025

Related U.S. Application Data
(60) Provisional application No. 63/690,788, filed on Sep. 4, 2024.

(51) Int. Cl. G06N 5/045

(52) U.S. Cl. CPC G06N 5/045

(57) ABSTRACT

A method for controlling an artificial intelligence (AI) deice can include receiving a user query corresponding to a task, determining, by a first large language model (LLM) based component corresponding to a look-ahead planning phase, a shortlisted set of potential actions from a plurality of available actions available based on a current state of an interactive environment, generating, by a second LLM based component corresponding to an agile navigation phase, a textual reason for selecting an action from the shortlisted set of potential actions, determining, by the second LLM based component, a single optimal next action from the shortlisted set of potential actions based on the textual reason, and executing the single optimal next action to transition the interactive environment to a new state.

### CROSS-REFERENCE TO RELATED APPLICATIONS

This non-provisional application claims priority under 35 U.S.C. § 119 (e) to U.S. Provisional Application No. 63/690,788, filed on Sep. 4, 2024, the entirety of which is hereby expressly incorporated by reference into the present application.

### BACKGROUND

### Field

The present disclosure relates to a device and method for an improved autonomous agent, in the field of artificial intelligence (AI). Particularly, the method can implement Language-based Efficient Agent utilization for Navigation (LEAN) based a multi-stage framework which can provide substantial enhancements in agent navigational accuracy and task completion, in which a generated reason can guide selection of a next action from a pre-planned, condensed set of candidate actions.

### Discussion of the Related Art

Artificial intelligence (AI) continues to transform various aspects of society and help users by powering advancements in various fields, particularly with regards to interactive applications, such as large language models (LLMs), chat-bots, and knowledge base question answering (KBQA) systems.

Further, the use of Large Language Models (LLMs) and agent-based systems is increasingly employed to assist users in complex decision-making and task-completion processes. These applications can span diverse areas, including online product recommendation and shopping, information retrieval from extensive databases, personalized planning services, and even robot control and management, aiming to provide users with relevant and timely assistance.

Existing systems attempting to leverage AI for such tasks often involve either direct interaction with a single, comprehensive LLM that processes a user query against a broad set of possibilities, or rely on simple database search mechanisms followed by rudimentary filtering. For instance, a user query for a product might be processed by an LLM attempting to parse details across an entire product catalog, or by a keyword search that returns a large, often noisy, set of initial results.

However, significant challenges arise when applying these existing AI approaches to tasks involving vast information spaces, such as navigating large e-commerce inventories, extensive knowledge bases, or complex environments. Directly employing a sophisticated LLM to evaluate every potential option at every step for completing a task can lead to prohibitive computational costs, high latency, and inefficient resource utilization, which can significantly degrade the user experience.

For example, an LLM agent tasked with a multi-step objective, such as purchasing a specific type of blue t-shirt from an e-commerce website, might expend considerable resources on unproductive actions. The agent may click on irrelevant product categories, fail to correctly utilize filtering mechanisms for size and color, or become unable to identify the correct sequence of actions required for checkout (e.g., “add to cart,” then “proceed to payment”).

This challenge extends beyond merely selecting an item from a list, rather it involves understanding the logical progression of steps required in a dynamic environment. Existing agents often lack a coherent, step by step reasoning process which may cause them to take actions that are inefficient or incorrect, and lead to task failure.

Further, existing strategies to manage this navigational complexity often involve either pre-scripting a rigid sequence of actions, or deploying extremely large and resource-intensive LLMs to re-evaluate the entire environment at every step using the entire context, which is not practical or economically viable. For example, the LLM may get stuck repeatedly trying the same action over and over again, or it may take a convoluted and inefficient path by selecting actions that are not logically relevant to the immediate sub-task, thereby failing to complete the objective within a reasonable number of steps. Some approaches may also attempt to fine-tune LLMs for specific websites, but this requires substantial effort and is not adaptable to new or rapidly changing environments.

Thus, a need exists for a more intelligent method that can dynamically plan a set of potential high-reward next steps and then use an explicit reasoning process to select and execute the most logical action to progress efficiently toward a goal.

Further, there exists a need for improved methods and systems that can more efficiently and effectively apply the advanced understanding capabilities of LLMs to sequential decision making in interactive environments. Such methods are needed to intelligently narrow the field of possible actions before applying this reasoning to ensure that the agent's decisions are both computationally efficient and contextually relevant to the overall task.

Furthermore, a need exists for a framework that can strategically integrate a planning phase with a reason based navigation phase to optimize resource utilization and enhance the scalability and accuracy of AI-driven agents in sequential and navigational tasks, in order to provide a more practical and powerful solution for assisting users.

Also, a need exists for a method that can achieve improved agent processing efficiency while enhancing the navigational accuracy and overall success rate of task completion in complex, interactive environments.

### SUMMARY OF THE DISCLOSURE

The present disclosure has been made in view of the above problems and it is an object of the present disclosure to provide a device and method that can provide improved agent processing efficiency and enhance the navigational accuracy and overall success rate of task completion, in the field of artificial intelligence (AI). Further, the method can provide improved AI agent processing efficiency and task completion success by systematically generating a textual reason to guide the selection of a next action from a pre-planned, condensed set of candidate actions for task completion.

An object of the present disclosure is to provide an artificial intelligence (AI) device and method for Language-based Efficient Agent utilization for Navigation (LEAN) that can enhance the efficiency and accuracy of AI-driven agents in completing complex navigational tasks. According to an embodiment, the method can include an iterative, multi-stage process performed at each step within an interactive environment. This process can include an initial look-ahead planning (LEAP) phase where a large language model (LLM) agent analyzes the current state of the environment to identify and shortlist a smaller group of highly promising potential actions. Then, these shortlisted actions can be passed to an agile navigation (LEAN) phase, in which an LLM agent generates a textual reason for acting, and then uses that reason to determine the optimal next action to execute, thereby enabling a computationally efficient and logically sound step by step navigation process.

Another object of the present disclosure is to provide a method for controlling an artificial intelligence (AI) device that can include receiving a user query corresponding to a task, determining, by a first large language model (LLM) based component corresponding to a look-ahead planning phase, a shortlisted set of potential actions from a plurality of available actions available based on a current state of an interactive environment, generating, by a second LLM based component corresponding to an agile navigation phase, a textual reason for selecting an action from the shortlisted set of potential actions, determining, by the second LLM based component, a single optimal next action from the shortlisted set of potential actions based on the textual reason, and executing the single optimal next action to transition the interactive environment to a new state.

It is another object of the present disclosure to provide a method that further includes iteratively repeating the determining the shortlisted set of potential actions, the generating the textual reason, the determining the single optimal next action, and the executing the single optimal next action until the task is completed.

Yet another object of the present disclosure is to provide a method, in which the iteratively repeating terminates upon one of the interactive environment reaching a final state corresponding to task completion or a predefined step limit being reached.

An object of the present disclosure is to provide a method, in which the generating the textual reason includes dynamically selecting an in-context example chunk from among a plurality of in-context example chunks based on a relevance of the in-context example chunk to the current state of the interactive environment, wherein the in-context example chunk includes a template for a successful interaction including at least an example previous action-observation pair and an example textual reason, and providing a prompt including the in-context example chunk to the second LLM based component for generating the textual reason.

Another object of the present disclosure is to provide a method that further includes the determining the single optimal next action includes dynamically selecting an in-context example chunk from among a plurality of in-context example chunks based on a relevance of the in-context example chunk to the current state of the interactive environment, wherein the in-context example chunk includes a template for a successful interaction including at least an example previous action-observation pair, the textual reason and an example determined next action, and providing a prompt including the in-context example chunk to the second LLM based component for determining the single optimal next action.

An object of the present disclosure is to provide a method, in which the determining the shortlisted set of potential actions includes analyzing, by the first LLM based component, a plurality of action-observation pairs, each of the plurality of action-observation pairs corresponding to one of the plurality of available actions and a corresponding resulting observation in the interactive environment.

Yet another object of the present disclosure is to provide a method, in which the analyzing the plurality of action-observation pairs is based on a reward model configured to score the potential actions based on a predicted utility for advancing the task.

An object of the present disclosure is to provide a method, in which the first LLM based component and the second LLM based component are based on different LLM models.

Another object of the present disclosure is to provide a method, in which the interactive environment is a web-based shopping environment, a household environment, or a software application interface.

An object of the present disclosure is to provide a method, in which the single optimal next action includes an automated action on behalf of a user, the automated action including at least one of initiating a purchase transaction for a product, booking a reservation, and controlling a robotic device.

Another object of the present disclosure is to provide a method, in which the textual reason is part of a reasoning trace, the reasoning trace including a textual output from the second LLM based component that articulates a logical justification for selecting the single optimal next action for ensuring the single optimal next action is consistent with a coherent strategy for completing the task.

Another object of the present disclosure is to provide an artificial intelligence (AI) device including a memory configured to store agent based prompt information, and a controller configured to receive a user query corresponding to a task, determine, by a first large language model (LLM) based component corresponding to a look-ahead planning phase, a shortlisted set of potential actions from a plurality of available actions available based on a current state of an interactive environment, generate, by a second LLM based component corresponding to an agile navigation phase, a textual reason for selecting an action from the shortlisted set of potential actions, determine, by the second LLM based component, a single optimal next action from the shortlisted set of potential actions based on the textual reason, and execute the single optimal next action to transition the interactive environment to a new state.

An object of the present disclosure is to provide a non-transitory computer readable medium storing computer-executable instructions that when executed by a processor, cause the processor to perform the operations of receiving a user query corresponding to a task, determining, by a first large language model (LLM) based component corresponding to a look-ahead planning phase, a shortlisted set of potential actions from a plurality of available actions available based on a current state of an interactive environment, generating, by a second LLM based component corresponding to an agile navigation phase, a textual reason for selecting an action from the shortlisted set of potential actions, determining, by the second LLM based component, a single optimal next action from the shortlisted set of potential actions based on the textual reason, and executing the single optimal next action to transition the interactive environment to a new state.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example framework for autonomous agents according to an embodiment of the present disclosure.

FIG. 5 illustrates an example encoder-decoder based transformer architecture for a large language model according to an embodiment of the present disclosure.

FIG. 6 illustrates an example of an autonomous agent performing tasks on a computer according to an embodiment of the present disclosure.

FIG. 7 illustrates an example of an autonomous agent performing tasks in a web shopping environment according to an embodiment of the present disclosure.

FIG. 8 illustrates an example framework of the AI model which can use curated context and agile navigation (LEAN) along with potential high-reward actions obtained via look-ahead planning, according to an embodiment.

FIG. 9 illustrates an example of navigation free autonomous agents performing tasks according to an embodiment of the present disclosure.

FIG. 10 illustrates an example flow chart for a method of controlling an AI device to implement a Language-based Efficient Agent utilization for Planning (LEAP) method according to an embodiment of the present disclosure.

FIG. 11 illustrates an overview of a pipeline architecture for the framework according to an embodiment of the present disclosure.

FIG. 12 illustrates an overview of a pipeline architecture for the framework which includes a reward model according to another embodiment of the present disclosure

FIG. 13 illustrates an example of an autonomous agent performing tasks in a web shopping environment according to an embodiment of the present disclosure.

FIG. 14 illustrates an example flow chart for a method of controlling an AI device to implement a Language-based Efficient Agent utilization for Navigation (LEAN) process according to an embodiment of the present disclosure.

FIG. 15 illustrates an example of an autonomous agent performing tasks in a household environment according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

For simplicity of explanation, a situation of an LLM based agent for online shopping is used an example, but embodiments are not limited thereto. For example, the LEAN model techniques disclosed herein can be applied to other types of situations and applications, such as information retrieval, travel planning, reservation assistance, customer support, route selection and planning, or any other type of application where a multi-stage filtering and selection process is beneficial. Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

According to an embodiment, the self-driving vehicle can be regarded as a robot having a self-driving function.

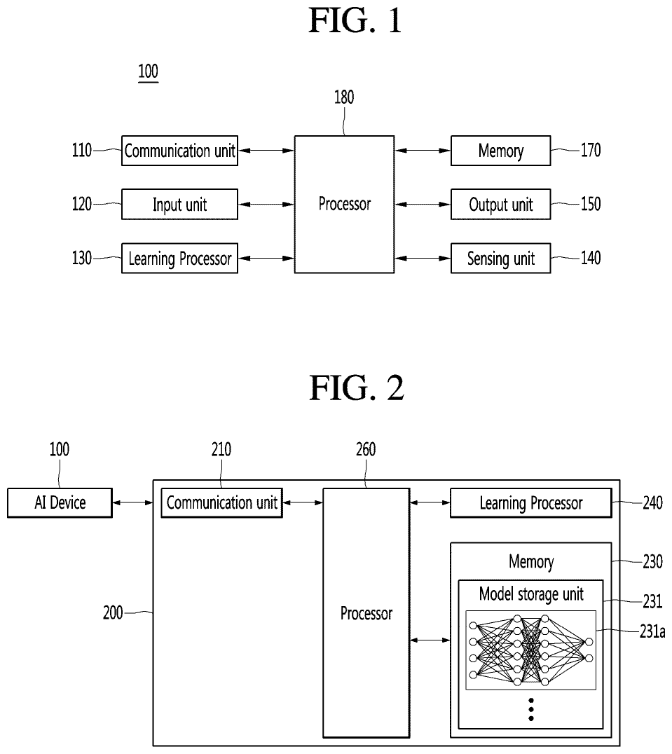

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

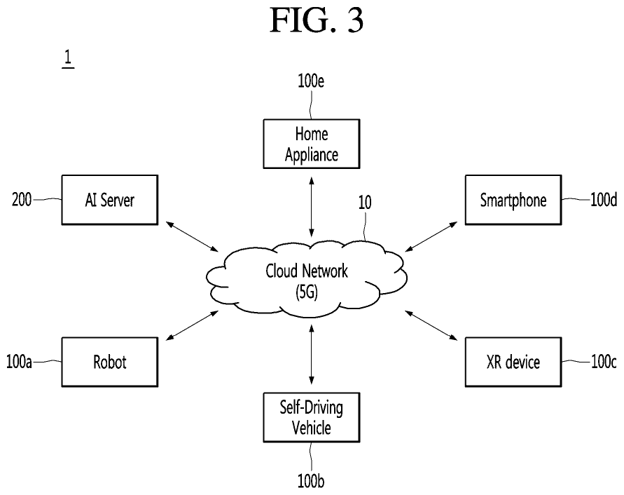

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

For example, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement Language-based Efficient Agent utilization for Navigation (LEAN) AI model to generate output based on a plurality of modalities. Also, the generated output can be used by AI systems in various downstream related tasks (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and can determine an emotional state of the user and produce an answer to a query, carry out an action or movement, animate a displayed avatar or a recommend an item or action based on the determined emotional state.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the Language-based Efficient Agent utilization for Navigation (LEAN) AI model can be fully implemented on an edge device (e.g., locally on devices 100a to 100e) or fully implemented AI server 200 in which an edge device collected the raw audio and video signals to provide to the AI server 200. According to another embodiment, parts of the LEAN AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of as a large language model (LLM), a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

In addition, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

Further, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's emotional state and personal preferences.

According to an embodiment, the AI device 100 can provide Language-based Efficient Agent utilization for Navigation (LEAN) for improved efficiency of agent actions for carrying out complex tasks with accuracy and quality. Further, according to an embodiment, the AI device 100 can implement a combination of Language-based Efficient Agent utilization for Planning (LEAP) and Language-based Efficient Agent utilization for Navigation (LEAN) to create an iterative, two-stage decision-making process, in which each step of a navigational task can first involve a planning phase (LEAP) to identify a short list of potential high-reward actions, followed by a navigation phase (LEAN) that uses agile prompting to generate a textual reason to select the next optimal action from that short list, to successfully complete a task.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to advancements in artificial intelligence (AI), particularly in the domain of AI agents. An artificial intelligence agent can be understood as a computational entity or system that perceives its environment through sensors or data inputs, processes this perceived information using internal logic or a model, and subsequently acts upon that environment through output mechanisms to achieve specific goals or tasks. The functionality of an AI agent is characterized by its ability to make decisions (e.g., either autonomously or semi-autonomously) linking its perceptions to actions in a rational or intelligent manner. Such agents can operate based on pre-defined rules and/or learned policies to optimize certain performance metrics over time.

For example, AI agents can be employed to perform a wide array of tasks across numerous fields. These tasks can include, but are not limited to, information retrieval and filtering from large datasets, providing personalized recommendations in e-commerce or content platforms, natural language understanding and generation for interactive dialogue systems, robotic control and navigation, scheduling and logistical planning, and complex problem-solving in domains such as finance or healthcare.

Further, the versatility of AI agents allows them to assist users by automating repetitive processes, offering decision support in complex scenarios, or managing interactions within digital or physical environments, particularly where intelligent adaptation or response to dynamic conditions is desired.

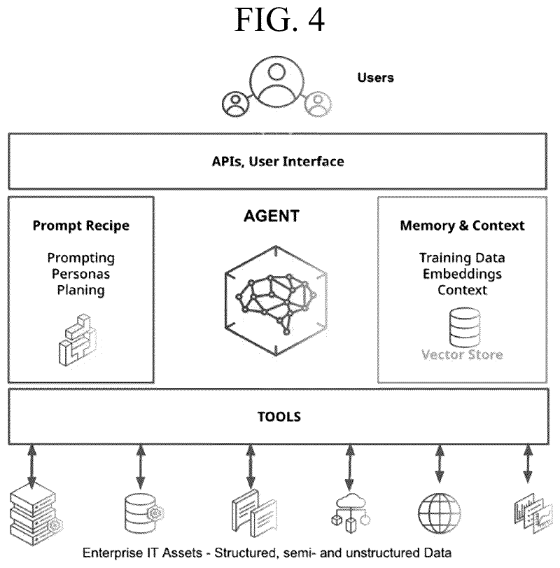

FIG. 4 illustrates an example framework for autonomous agents according to an embodiment of the present disclosure. Various types of AI agents can be distinguished based on their architecture, capabilities, and the sophistication of their decision-making processes. A brief overview includes simple reflex agents that act solely based on current percepts condition. Model-based reflex agents can maintain an internal state or model of the world to inform their actions. Goal-based agents can possess explicit goal information and select actions designed to achieve those goals. Utility-based agents can further refine this by selecting actions that maximize an expected utility or performance measure, allowing for trade-offs between conflicting goals or uncertain outcomes.

Furthermore, learning agents are capable of improving their performance over time by learning from experience and adapting their internal models or decision policies. According to embodiment, the AI model and method described herein can leverage or interact with principles from one or more of these agent types, particularly in the context of advanced learning agents incorporating large language models.

As discussed above, existing AI agent technology faces several issues. While AI agents offer considerable promise for assisting users in complex task completion, such as executing multi-step objectives in interactive environments, their practical application is often encumbered by several significant challenges. These challenges can impair their efficiency, navigational accuracy and overall effectiveness, particularly when confronted with the dynamic and intricate nature of real-world applications that require a logical sequence of actions or sub-steps to complete a goal.

For example, one type of challenge relates to navigational complexity and computational cost, especially when AI agents are tasked with operating in environments with a large “action space” (e.g., many possible actions at each step). For instance, on a typical e-commerce webpage, an agent might need to choose from dozens of clickable buttons, links, and input fields. For a task requiring ten sequential actions, the number of possible paths can become computationally explosive. Employing a single, complex LLM pass to perform an exhaustive analysis of all possible action sequences is computationally prohibitive, leading to unacceptable latency and high operational costs, or even task failure.

Further difficulties arise in maintaining logical consistency and task focus throughout a multi-step navigation process. As an agent moves through an environment, it may struggle to track the overall objective while determining the correct next action. This lack of a coherent reasoning process often leads to common failure modes, such as the agent getting stuck in a repetitive loop (e.g., repeatedly clicking back and forth between two pages), becoming sidetracked by irrelevant but selectable options, or attempting to perform actions out of their required logical order, such as trying to “checkout” or buy something before an item has even been added to a cart.

Also, existing agents exhibit limitations in their ability to both plan and act effectively. They often lack a multi-stage process for first narrowing down the vast field of possible actions to a relevant, manageable subset, and then applying a deeper, more nuanced logic to select the single best action from that subset to pursue next. For example, agents either incur substantial computational overhead by deeply analyzing too many irrelevant actions or act impulsively based on simplistic filtering, causing them to miss the optimal path.

Thus, the limitations inherent in related-art AI agent methodologies for navigational tasks frequently result in a suboptimal trade-off between inefficient, brute-force exploration and adherence to an inflexible, pre-scripted plan. Accordingly, a need exists for improved systems and methods that can more intelligently manage a large action space and apply a step-by-step reasoning process that can enable AI agents to successfully navigate complex environments and complete their objectives.

According to an embodiment, a device and method for Language-based Efficient Agent utilization for Navigation (LEAN) to carry out complex navigational tasks is provided. For example, the method can include an iterative, two-stage process that is performed at each step of carrying out a task within an interactive environment. The process can begin with a look-ahead planning (LEAP) phase in which a large language model (LLM) agent intelligently analyzes the current state of the environment to identify and shortlist a smaller group of highly promising potential actions. Then, these shortlisted actions can be passed to an agile navigation (LEAN) phase, in which a LLM agent generates a textual reason for acting, and then uses that reason to determine and execute the single, best next action, thereby enabling a computationally efficient yet logically sound step-by-step navigation process.

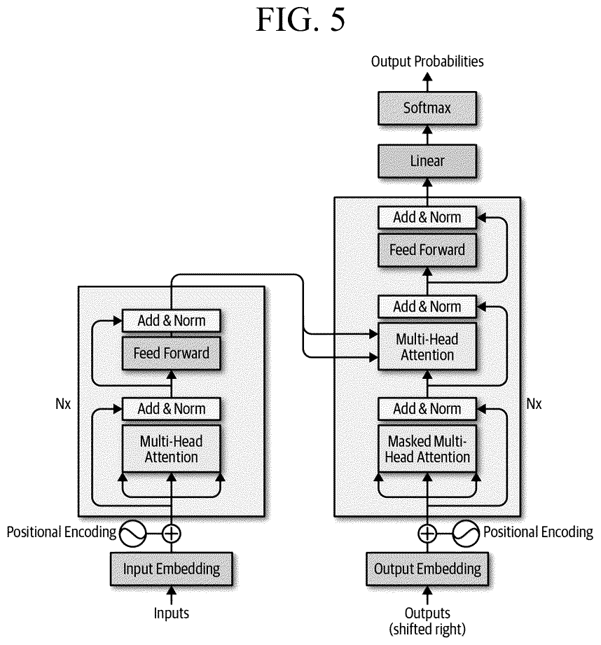

FIG. 5 illustrates an example encoder-decoder based transformer architecture for a large language model according to an embodiment of the present disclosure. For example, the LEAN method can leverage a large language model (LLM). According to an embodiment, the LLM can be based on an encoder-decoder architecture, which employs self-attention mechanisms.

Further, these attention mechanisms can allow the model to weigh the importance of different parts of an input sequence (e.g., words in a sentence or sentences in a document) when processing information, enabling the model to capture long-range dependencies and contextual relationships effectively, which is particularly relevant for understanding complex user queries or detailed product description.

According to an embodiment, the LLM can undergo a pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portion can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics, such as improved instruction following or safety protocols. According to embodiments, the LEAN AI model can advantageously utilize pre-trained LLMs, potentially without requiring extensive task-specific fine-tuning for its core agent functionalities. For example, according to an embodiment, the LEAN AI model can be LLM agnostic, but embodiments are not limited thereto.

For example, the LLM portion can operate by processing textual inputs (e.g., prompts) which can include questions, instructions, or other text intended to elicit a specific response. The LLM can leverage its learned knowledge to generate a corresponding textual output, such as an answer, a summary, or other contextually relevant content. Also, according to an embodiment, the LLM portion can be multi-modal to accept and operate on other types of input, such as images, video, etc.

According to embodiment, the Language-based Efficient Agent utilization for Navigation (LEAN) AI model can provide an improved intelligent LLM-based agent process that can efficiently and accurately perform complex tasks. Embodiments of the LEAN framework are directed to a multi-stage method and device for agent utilization that can systematically process information and narrow down options and perform agile reasoning to select the next, best action, thereby optimizing the use of computational resources and agent capabilities. Further, this structured approach can address shortcomings in related art systems where a monolithic or less structured application of AI agents to large action spaces may lead to inefficiencies or suboptimal outcomes.

For example, according to an embodiment, the LEAN AI model can provide a significantly improved approach for task completion, especially in scenarios involving extensive data and numerous potential choices, such as, but not limited to, online product selection and purchase, information retrieval, personalized planning, or even robot command and control.

Further, the LEAN method can enhance the ability of AI-driven systems to assist users by providing more relevant, accurate, and timely results or recommendations. This can be achieved by intelligently dividing the overall task into distinct phases, each tailored to a specific level of analysis and filtering, thereby improving upon existing methodologies that may lack such granular control and staged refinement. In this way, the method can provide a more robust and efficient process for arriving at a desired outcome or decision, such as carrying out a complex task to realize a user's goal.

According to an embodiment, the AI model and method can provide improved task completion for navigational objectives through a structured, iterative workflow. For example, this iterative process, performed at each step of a task, can progressively determine the single, optimal next action to take, thereby creating an efficient and logically coherent path to the final goal.

According to an embodiment, the two primary phases of this iterative method can include a look-ahead planning (LEAP) phase and an agile navigation (LEAN) phase, in which these two phases work in sequence to systematically determine the next action at each step for carrying out a task. The LEAP phase can first reduce the entire action space to a manageable subset of high-potential actions, and the LEAN phase can then use a generated textual reason to select the single best action from that subset execute next for working towards completing a goal (e.g., responding to a user query or command). This AI method can be applied to various types of situations and applications requiring autonomous navigation.

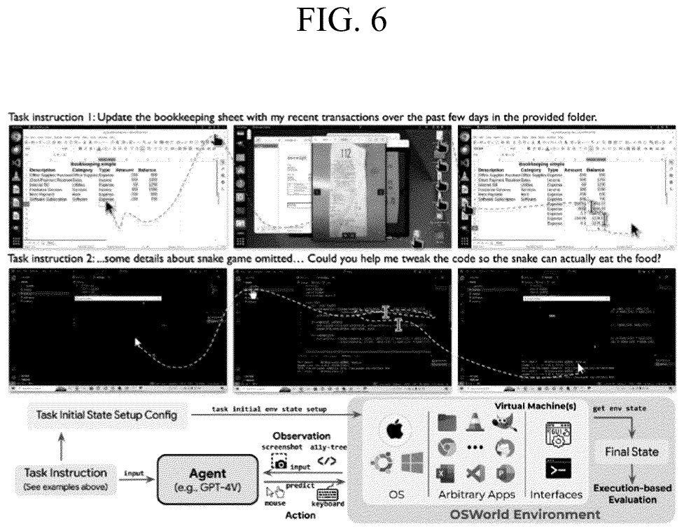

FIG. 6 illustrates an example of an autonomous agent performing tasks on a computer according to an embodiment of the present disclosure. For example, the AI model can be applied to a situation for carrying tasks on a user's personal computer (e.g., book keeping, budgeting, etc.).

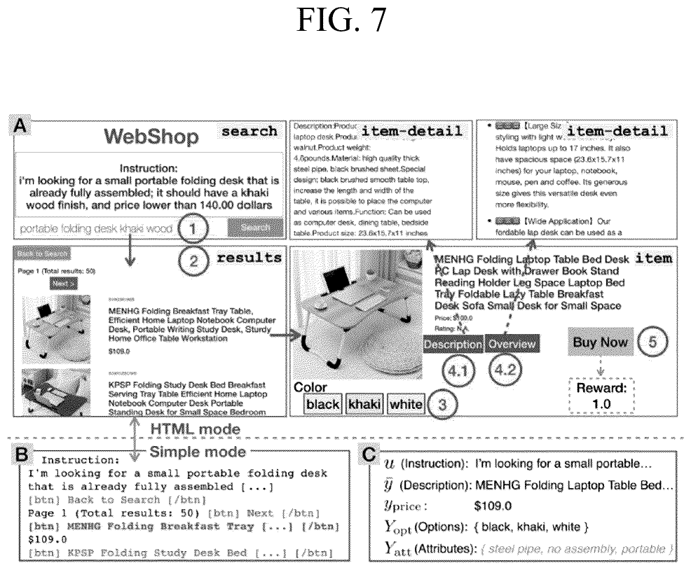

FIG. 7 illustrates an example of an autonomous agent performing a task in a web shopping environment according to an embodiment of the present disclosure. For example, the AI model can be applied to a situation requiring a sequence of actions to purchase an item online on behalf of a user.

For example, the process can begin with a look-ahead planning (LEAP) stage. This LEAP stage can involve analyzing the agent's current state within the interactive environment (e.g., the current webpage's HTML content). The system can first identify all possible actions in this state, such as all clickable elements and input fields, which constitute the “action space.”

According to an embodiment, the LEAP stage can include an initial database search phase to perform a broad, initial filtering of a large corpus of items or data points (e.g., an extensive product catalog, a vast document repository) based on a user query or specified criteria. Also, this search phase can be based on various search methodologies, such as keyword-based searching, indexed database queries, or other forms of information retrieval that do not necessitate the computational resources of a large language model (LLM). The output of the initial database search phase can be a subset of items that are broadly relevant to the user's input or query.

Further in this example, the resulting subset of items from the database search can be passed to an explore phase. The explore phase can leverage an LLM to further intelligently shortlist promising candidates from the subset generated by the database search. For example, an LLM-based agent can analyze the items in the subset such as focusing on primary or readily discernible characteristics (e.g., titles, prices, key features, summary descriptions) in relation to the user query to identify a smaller, more manageable list of candidates that exhibit a higher likelihood of satisfying the user's need or intent.

For example, first LLM-based agent can analyze the potential actions in relation to the overall user query (e.g., “buy a blue t-shirt”) to identify a smaller, more manageable list of actions that exhibit a higher likelihood of advancing the task.

Also, according to an embodiment, the explore phase (e.g., shortlisting in the LEAP stage) can include a reward model component, which can help score the candidate actions based on their predicted utility for moving the agent closer to its final goal.

In addition, the reduced list of candidate actions produced by the LEAP stage can proceed to the agile navigation (LEAN) stage. According to an embodiment, the LEAN stage can use an LLM-based agent that generates a textual reason for acting. For example, it might generate the reason, “To find a specific item, using the search bar is the most direct method.” Based on this generated reason, the agent can then determine and execute the single, optimal next action. This action transitions the environment to a new state, and the iterative LEAP and LEAN process can begin again.

Also, according to an embodiment, the LLM-based agent for the LEAN stage can be based on the same LLM as in the LEAP stage but operating under a different set of instructions or prompts, but embodiments are not limited thereto. For example, according to an embodiment, a different LLM model can be used for the LEAN stage than the LLM model that was used in the LEAP stage, e.g., a distinct, potentially more specialized or powerful LLM, etc.

Also, according to an embodiment, the LEAN stage can be omitted and replaced with an exploit module. For example, in situations that do not require complex navigation (e.g., in situations where full access to backend database information is available) and also for ease of explanation, the LEAN stage can be replaced with a simpler exploit phase.

For example, according to an embodiment, the reduced list of candidates produced by the explore phase can proceed to the exploit phase. According to an embodiment, the exploit phase can use another LLM-based agent that conducts a detailed and nuanced analysis of the shortlisted candidates. For example, an in-depth examination can be performed for specific attributes, compare options comprehensively, consider subtle trade-offs, and ultimately determine and output a final most suitable item, plan, or piece of information as the final selection. This final selection can then be presented to the user or carried out on the user's behalf (e.g., a product purchase) or utilized for subsequent automated actions (e.g., controlling or moving a robot).

Also, the LLM-based agent for the exploit module can be based on the same LLM as in the explore phase but operating under a different set of instructions or prompts, but embodiments are not limited there. For example, according to an embodiment, a different LLM model can be used for the exploit phase than the LLM model that was used in the explore phase, e.g., a distinct, potentially more specialized or powerful LLM, etc.

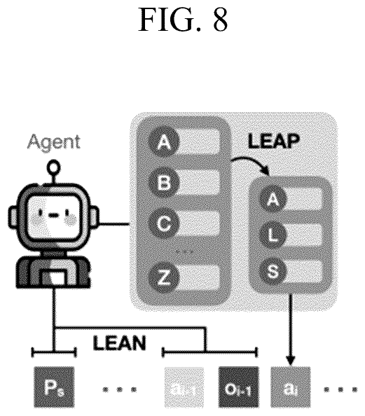

FIG. 8 shows an example framework of the AI model which can use curated context and agile navigation (LEAN) along with potential high-reward actions obtained via look-ahead planning (LEAP), according to an embodiment.

For example, FIG. 8 illustrates a two-stage framework to determine an optimal action within an interactive environment based on a given task. The process can begin with stage I, Look-ahead Planning (LEAP), where the agent analyzes the current observations from the environment to produce a short-list of potential high-reward actions (e.g., A, L, S).

This short-list can then be passed to stage II, agile navigation (LEAN). In this second stage, the agent curates its decision making context by first generating a textual reason for acting based on the overall task and the high-potential actions. Then, the agent can use this generated reason along with the short-listed actions and previous action-observation pair to select the single, optimal next action (e.g., ai) to be executed in the environment, completing one full cycle of the iterative decision making process.

For example, in more detail, the Agile Navigation (LEAN) phase (e.g., stage II) can include a unique two-prompt methodology that decouples the act of reasoning from the act of final action selection. This can provide a deliberate and logically sound decision making process at each step of a navigational task. For each set of candidate actions provided by the preceding LEAP phase (e.g., stage I), the agent prompts an LLM twice, such as first, to generate a textual reason for acting, and then second, to use that reason to select the single, optimal next action.

Further in this example, the first prompt is for reason generation. For example, an LLM-based agent can be provided with a curated set of inputs including a system prompt that defines its role, the user query which contains the overall task description, a relevant in-context example to guide its output format, and the most recent action-observation pair to ground it in the current state of the environment. The objective of this first LLM call is to produce a reasoning trace, which is a textual explanation of the logical basis for the subsequent action. This step can guide the agent to explicitly formulate its intention before acting.

Further still in this example, the second prompt in the process is for action selection and execution. This prompt can include all the inputs from the first prompt along with the addition of the newly generated reason to take the next action. By including the reasoning trace as an explicit input, the second LLM call can be directly conditioned on the logical justification formulated in the first step. This can help ensure that the final selected action is a direct and logical consequence of the agent's articulated reasoning.

This two-prompt cycle of “reason then act” can be repeated at each step of the task to provide a robust and efficient method for navigating complex environments.

According to another embodiment, the acquisition of detailed information can be accomplished without requiring explicit navigation of web page interfaces by an automated agent (e.g., the LEAN stage can be replaced with a simplified exploit module). In such configurations, the environment can be designed such that all necessary information for the detailed look-up or analysis phase can be retrieved directly from a backend database, structured data feeds, or similar directly queryable data sources. While conceptual navigation might occur, such as selecting an item from a list generated by the explore module to access its full record, the system can obviate the need for an agent to interact with and parse dynamic web page elements like drop-down menus or selectable options on a live website. The underlying data architecture in these embodiments can permit direct fetching of comprehensive item attributes and details once an item has been shortlisted.

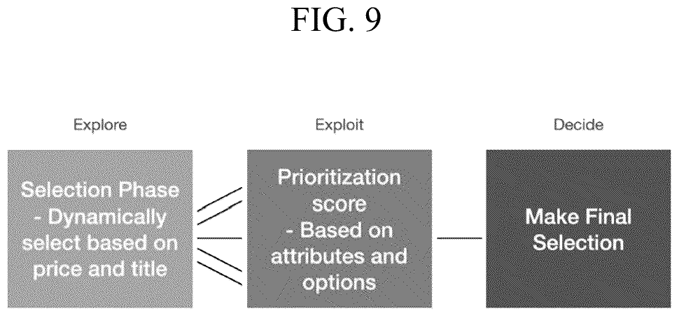

FIG. 9 illustrates an example of navigation free autonomous agents performing tasks according to an embodiment of the present disclosure. For example, in environments where such direct backend access to detailed information is available, thereby eliminating the need for explicit UI navigation for data gathering (e.g., LEAN), the LEAP framework's operational flow can be represented in a more streamlined or distilled manner, for example, as shown in FIG. 9.

In other words, according to another embodiment, the LEAN stage can be replaced with a simpler exploit phase or exploit module. For example, the following section focuses on explaining the details of stage I regarding look-ahead planning (e.g., LEAP) for ease of explanation. The details regarding stage II (LEAN) are discussed in more detail at a later section below.

For example, an agent employing the framework can still effectively complete its task by performing at least one round of a partial look-up to initially vet candidates based on primary information, followed by at least one round of a detailed look-up utilizing the directly accessed comprehensive information. This sequence can ensure that sufficient data is analyzed for informed, final decision-making by the agent.

Further, the exploit module can synthesize this comprehensive information for each product or item and perform comparative evaluations across the candidates. For instance, the exploit module can weigh different features, assess compatibility with user-stated constraints, and/or infer the overall suitability of each option to achieve the user's task or satisfy user preferences.

Based on this comprehensive analysis and comparison, the LLM agent in the exploit module can determine a final selection. The criteria for this final selection can be to identify the single best match, the item with the highest predicted utility, or the most relevant product that aligns with the user's query and inferred intent. This process can involve a final internal re-ranking of the few candidates, with the top-ranked item being chosen. The output of the exploit module can be the selected final item or product (e.g., represented by its unique identifier or product ID) which can then be designated for purchase, recommendation to the user, or initiation of a subsequent action.

According to an embodiment, a method directed to LEAP with the exploit module can include purchasing and ordering the final selected item, and having it shipped to a predetermined address or destination associated with the user.

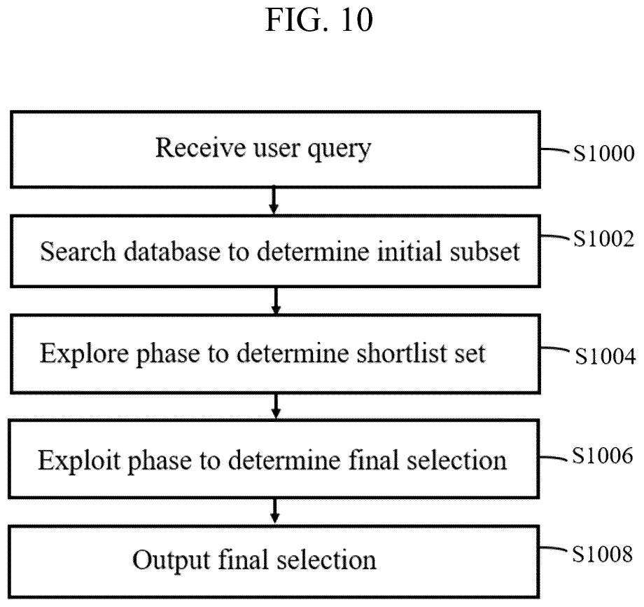

FIG. 10 shows an example flow chart of a method according to an embodiment of the present disclosure. For example, according to an embodiment, a method for controlling an AI device can include receiving, by a processor in the AI device, a user query (e.g., S1000), searching a database to determine an initial subset of items based on the user query (e.g., S1002), determining, via a first large language model-based agent corresponding to an explore phase, a shortlisted set of items from among the initial subset of items (e.g., S1004), determining, via a second large language model-based agent corresponding to an exploit phase, a final selection from the shortlisted set based on a detailed analysis of attributes and options associated with items within the shortlisted set (e.g., S1006), and outputting the final selection (e.g., S1008).

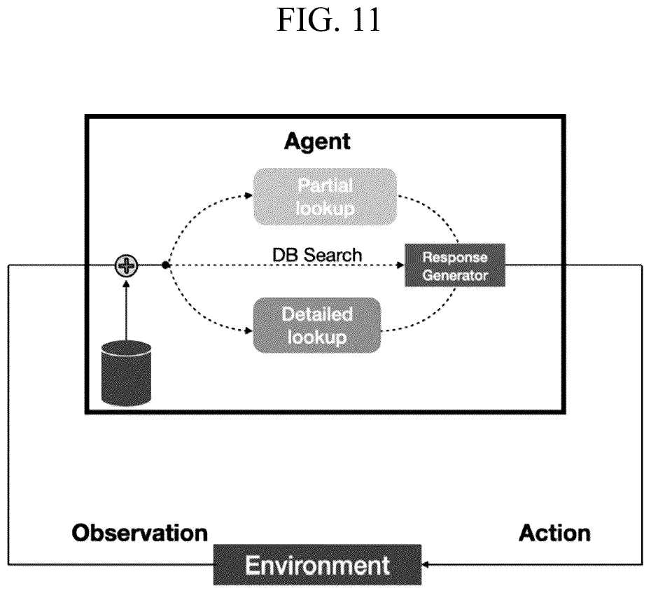

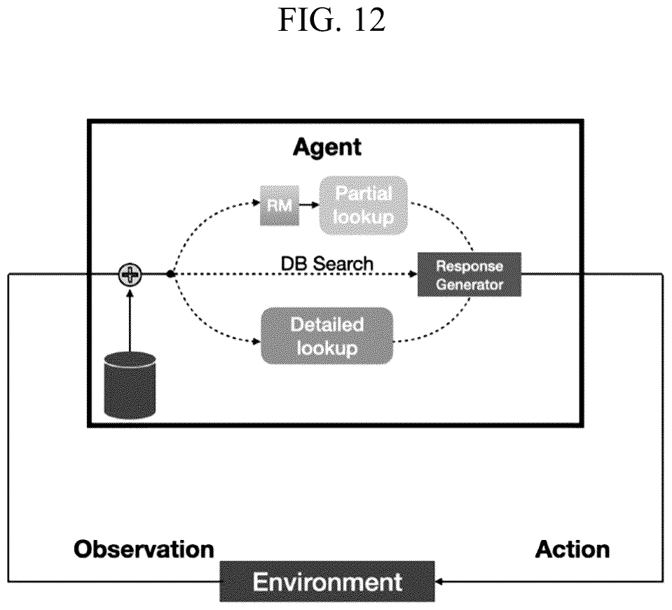

FIG. 11 illustrates an overview of the pipeline architecture of a AI model, according to an embodiment of the present disclosure. For example, according to an embodiment, the AI model can be implemented as a cohesive architecture of interconnected modules designed to implement the multi-phase workflow previously described.

For example, the AI device 100 implementing the AI model with a LEAP stage including an exploit module can be configured to receive one or more inputs, such as a user query, which can specify a user's need or intent, and access a database or a similar extensive corpus of items, products or data points. The inputs can initiate a process where data can flow sequentially or interactively through various processing modules, such as a database search module, an explore module, and an exploit module, which will be described in more detail below.

Further, this processing can generate one or more outputs, such as a selected final product, a recommended action, or a curated piece of information, which represents the model's determination of the optimal outcome responsive to the user query and based upon the information within the database.

In more detail, the method can initiate a process with a database search module. The database search module can efficiently conduct an initial, broad-level filtering of a large search space. This initial filtering can substantially reduce the volume of data that needs to be processed by subsequent, more computationally intensive modules, such as those employing large language models (LLMs). According to an embodiment, this phase can operate without the direct involvement of an LLM to ensure high speed and efficiency when dealing with potentially vast datasets.

Further in this example, inputs to the database search module can include at least two main components, e.g., a user query and access to a database. The user query can be a textual input provided by a user, which can represent the user's needed task, question, or desired product/information. The database can represent a large corpus of items, such as an e-commerce website's inventory which might contain information on millions of individual products, including their descriptions, specifications, attributes and other associated metadata.

According to an embodiment, the processing within the database search module can be performed by a search mechanism configured for rapid retrieval from the database based on the user query. A characteristic of this stage is that the search mechanism may not be an LLM-based search, but embodiments are not limited thereto. Rather, the database search module can employ various information retrieval techniques.

For example, the search logic can be based on keyword matching, where terms from the user query are matched against terms in the product information, or exact matching schemes. In some embodiments, the database search module can leverage fast retrieval systems, such as those utilizing algorithms like Okapi BM25, Pyserini, or Elasticsearch. The user query can be taken as input and the model can perform a coarse search over the available items. Initial relevance can be determined based on the scoring methodology of the employed search algorithm (e.g., BM25 score), which can rank items based on their statistical relevance to the query terms.

The output of the database search module can be an initial subset of potentially relevant items or products. This output can represent a significantly reduced set compared to the entirety of the database. For example, from an initial one million products, this phase might output a list of approximately one hundred top-ranked products deemed most relevant by the coarse search mechanism. This initial subset of items, along with potentially their relevance scores from this phase, can then be provided as input to the subsequent explore module for further, more nuanced processing.

Subsequent to the initial filtering performed by the database search module, the method can employ an explore module (e.g., partial lookup), see FIG. 9. The explore module (e.g., partial lookup) can serve as the first stage within the LEAP framework where a Large Language Model (LLM) based agent is utilized, but embodiments are not limited thereto.

For example, the purpose and functionality of the explore module can be to perform an intelligent and semantic shortlisting of candidate items from the potentially large and somewhat coarsely filtered subset received from the database search module. This explore phase can bridge the gap between broad, keyword-based retrieval and deep, nuanced understanding by introducing LLM-driven analysis at an intermediate stage.

Further, the inputs to the explore module can include (i) the initial subset of potentially relevant items or products output by the database search module, and (ii) the original user query (e.g., user query), which can also be further supplemented with any refined aspects or contextual information derived from earlier processing or user interaction. This input provides the LLM agent within the explore module with both the candidate items and the user's articulated need or task.

The explore module can be based on a first LLM agent. While various types of LLMs characterized by robust natural language understanding (NLU) and generation (NLG) capabilities can be employed, this first LLM agent can be specifically configured for the task of efficient shortlisting. This configuration can include strategic prompt engineering, in which the LLM is provided with carefully designed instructions or prompts that guide its analysis.

As shown in Table I below, an example LEAP prompt template is provided for the explore phase that explores primary information based on a WebShop environment, but embodiments are not limited thereto.

TABLE I

| | |
|---|---|
| Prompt | Follow my instructions properly. |
| Template | You are a real world agent who is shopping on the web. |
| | Select for me top-5 products with best matching options and features for |
| | “[Search_Instruction]″ |
| | The details of the products available on the web are as below in json format. |
| | Please select only best matching product_ids. |
| | { |
| | [Search_Result_Products] |
| | } |
| | Only return 5 product ids from the json provided. |
| Prompt | Follow my instructions properly. |
| Example | You are a real world agent who is shopping on the web. |
| | Select for me top-5 products with best matching options and features for “black |
| | high quality cenglings womens cowl neck sweatshirt″ |
| | The details of the products available on the web are as below in json format. |
| | Please select only best matching product_ids. |
| | { |
| | ″B09MTX95LM″: ″ViYW Women's Floral Print Shirts Button Cowl |
| | Neck Long Sleeve Tunic Tops Fashion Autumn Warm Blouses Casual Soft Tee |
| | ; Price: $7.99 to $20.99″, |
| | ″B09M472NR″: ″JJSUnS Women's Warm Long Sleeve Jackets With |
| | Hood Full Zip Up Fall Winter Tie Waist Coats Hoodie Windproof Outwear ; |
| | Price: $28.99 ″, |
| | ... |
| | ... |
| | ″B09H599BPH″: ″Women Y2K Hooded Sweatshirt, Unisex Los An- |
| | geles California Hoodies Retro Long Sleeve Pullovers Distressed Tops ; Price: |
| | $6.98 to $15.99″, |
| | ″B07Y9K759Z″: ″Barlver Women's Casaul Long Sleeve Sweatshirts |
| | Fleece Cowl Neck Pullover Top Tunic Blouse Outwear ; Price: $12.99″, |
| | ... |
| | ... |
| | ″B09PL8RNS9″: ″WENKOMG1 Men's Thin Henley Shirts Comfy |
| | Casual T-Shirt Long Sleeve V-Neck Tops Regular-Fit Oversize Blouse Business |
| | Solid Color Polo Shirts Spring/Summer Sweatshirt(Gray,3X-Large) ; Price: |
| | $5.59″, |
| | ″B09PLJ9RDX″: ″WENKOMG1 Oversize T-Shirt for Men Long Sleeve |
| | Henley Shirts Casual Thin Tops Loose Solid Color Polo Shirts V-Neck Business |
| | Blouse Comfy Spring/Summer Regular-Fit Sweatshirt(Blue,XX-Large) ; Price: |
| | $5.19 ″ |
| | } |
| | Only return 5 products ids from the json provided. |

Another aspect of this explore phase is its focus on primary information associated with each candidate item. Such primary information can include, for example, product titles, short descriptions, prices, key features explicitly mentioned in summaries, and other data readily available without requiring a deep dive into detailed product pages or extensive linked information (e.g., such as drilling down into different attributes and options). This focus can help ensure that the explore module can process a relatively large number of candidates efficiently.

During processing, the LLM agent within the explore module can analyze the primary information of each item in the received subset in the context of the user query. This analysis can leverage the LLM's semantic understanding capabilities to perform a more sophisticated evaluation than simple keyword matching.

For example, where a database search might struggle to differentiate between homonyms or to grasp the true intent behind a query (e.g., matching “apple phone” to any product containing “apple” and “phone”), the LLM agent in the explore module can better discern semantic relevance, such as identifying an “iPhone” as the likely target for “apple phone” over other apple-branded products or actual apples or fruit. This can be conceptualized as an LLM-powered re-ranking or semantic filtering process, in which items are evaluated based on the semantic similarity of their primary information (e.g., title, short description) to the user query. This partial look-up capability can allow for a more nuanced initial assessment of relevance.

In addition, the LLM based agent in the explore module can also incorporate a form of look-ahead assessment or planning to further refine the shortlisting. In this context, the LLM agent can evaluate items (which can be considered potential “actions” for further consideration) by examining their available primary information (an “observation” associated with the item) against the task requirements defined by the user query.

For example, this look-ahead capability can allow the agent to intelligently anticipate or predict the potential of an item to satisfy the user's ultimate goal, even with the limited information available at this stage. By matching available item information with task requirements, the LLM agent can select a limited set of candidates perceived to have a high potential for relevance or utility which can reduce the exploration space for subsequent phases. For example, the criteria for shortlisting can involve selecting a top N number of candidates (e.g., the top 5 to 10 items or actions) that receive the highest relevance scores or classifications from the LLM agent.

FIG. 10 illustrates an overview of a pipeline architecture for the LEAP framework (e.g., stage I) according to another embodiment of the present disclosure. As shown in FIG. 10, according to an embodiment, the explore module can also interface with a reward model that can assess the quality of the candidates and/or provide feedback to adapt the LLM agent's parameters or prompting strategies over time.

For example, the reward model can be a specialized model trained to predict or quantify the likely human preference for a given output (e.g., a piece of text, a product selection) in response to a specific input or prompt (e.g., a user query). The reward model can be trained on datasets including examples of human preferences, such as comparisons between different responses to the same prompt (e.g., prompt-chosen-rejected trios).

In addition, through this training, the reward model can learn to assign a scalar score or a probability distribution indicative of the degree to which an item or response is likely to align with human preferences or satisfy the underlying intent of a given query (e.g., a score between 0 and 1). The output of the explore module can be a first reduced set of candidate items or products. This set is significantly smaller and more semantically refined than the result received from the database search module.

Within the architecture of the LEAP framework, the reward model can be strategically incorporated, for example, between the database search module and the explore module. In this configuration, the inputs to the reward model can include (i) the user query, serving as the contextual prompt, and (ii) the initial subset of potentially relevant items or products that are output by the database search module. Each item in this subset, along with its associated primary information (e.g., title, brief description), can be considered a potential “completion” or response to the user query.

The functionality of the reward model in this position within the LEAP workflow can be to further refine and prioritize the subset of items received from the database search module. For each item in the subset, the reward model can generate a preference score (e.g., a score between 0 and 1, such as 0.8). This score can be determined by the reward model based on its learned model of human preferences as applied to the specific user query and the available information for that item.

For example, according to an embodiment, the reward model can be trained on e-commerce preference data to assess how likely a user issuing a particular query is to prefer one product over another from the initial search results, based on features like product category, brand, or alignment of descriptive terms with nuanced aspects of the query that a purely keyword-based search might miss. The output of this reward model stage can be the same subset of items augmented with these preference scores, or, alternatively, the subset can be re-ranked according to these scores.

For example, the incorporation of the reward model can provide several benefits to the subsequent explore module and the overall LEAP architecture. By providing an intermediate layer of preference-based scoring or re-ranking, the reward model can help focus the analytical efforts of the LLM agent in the explore module on the most promising candidates.

For instance, the explore module can be configured to process only the top N items as ranked by the reward model, thereby reducing its computational load. Alternatively, the preference scores from the reward model can be used as an additional input feature or heuristic for the explore module's LLM agent to guide its own shortlisting process. This pre-emptive refinement by a specialized reward model can enhance the overall efficiency, speed, and potentially the accuracy of the LEAP framework (e.g., stage I) in identifying the optimal final selection that aligns with user preferences.

For example, according to an embodiment, the reward model can perform an additional shortlisting step on items received from the database search module, before these items are processed by the LLM based agent of the explore module. This reward model can take as input the user query and high-level details (such as price and title) for each product provided by the database search. For each such product, the reward model can then generate a numerical relevance score within a defined range (e.g., 0 to 1), indicating the product's assessed relevance to the user query. Following the scoring, these products are commonly sorted by their scores, and a predetermined top fraction (e.g., the highest-scoring half) can be selected, thereby creating a further reduced intermediate list of candidate products.

Further, this intermediate list of candidate products scored and filtered by the reward model can be passed as input to the explore module. An advantage of incorporating this reward model stage can be the substantial reduction in the number of items requiring evaluation by the more computationally intensive LLM agent of the explore module. For example, by pre-qualifying and narrowing the set of candidates based on key features, the reward model can enhance the overall computational efficiency and processing speed of the LEAP framework (e.g., stage I). This can allow the model to focus its semantic analysis on a smaller, more relevant set of items.

As shown in Table II below, an example reward model input text template and example is provided, but embodiments are not limited thereto.

TABLE II

| | |
|---|---|
| Input | [ |
| template | { |
| | “role”: “user”, |
| | “content”: goal_instruction |
| | }, |
| | { |
| | “role”: “assistant”, |
| | “content”: product |
| | }, |
| | ] |
| Input | [ |
| example | { |
| | “role”: “user”, |
| | “content”: I need gluten free |
| | vegetarian smoked peppered |
| | bacon - 4 ounce (pack of 2), and |
| | price lower than 50.00 dollars. |
| | }, |
| | { |
| | “role”: “assistant”, |
| | “content”: $64.99 - |
| | OMEALS Pasta Fagioli Six |
| | Vegetarian MRE Sustainable |
| | Premium Outdoor Fully Cooked |
| | Meals w/Heater - Extended |
| | Shelf Life - No Refrigeration - |
| | Perfect for Travelers, Emergency |
| | Supplies - USA 6 Pack |
| | }, |
| | ] |

Further in this example regarding the interaction between the database search module and the explore module, an input of approximately one hundred items might be reduced to about five to ten highly promising candidates. This output, which can include the shortlisted items themselves along with any associated relevance scores, semantic interpretations, or pertinent information about why these items were selected (e.g., representing “potential actions and consequences” in an abstract sense), can then passed as input to the subsequent exploit module for detailed, in-depth analysis.

Also, as mentioned earlier above, the exploit module can be replaced with LEAN (stage II) for situations in which complex navigation is desired, such as navigation a website that has multiple webpages, options and dropdown menus, etc. (e.g., stage II is discussed in more detail at a later section).

According to an example, the initial database search phase can search a database of one million products and reduce it to a subset of about 100 top potential picks, and then the explore phase can reduce this subset even further to produce the 5 or 10 candidates, which can be passed to the exploit module.

With reference again to FIG. 9, following the shortlisting and semantic refinement performed by the explore module, the method can proceed to its final primary processing stage, the exploit module (e.g., detailed lookup), which can also include a response generator. The purpose and functionality of the exploit module (e.g., detailed lookup) can be to conduct a comprehensive and detailed analysis of the highly promising, small set of candidate items (e.g., the top 5 products) received from the explore module to select one best item for the task.

Based on this in-depth evaluation, the exploit module (e.g., detailed lookup) can make the final selection of a single item, product, service, or plan that is determined to best satisfy the original user query and objectives.

For example, the inputs to the exploit module (e.g., detailed lookup) can include (i) the reduced and refined set of candidate items outputted by the explore module, and (ii) the user query. Also, for the few candidates under consideration in this phase, the exploit module can leverage substantially more detailed information than was utilized in the preceding explore module. This detailed information, can include not only primary data like price and title, but also comprehensive attributes, available options (e.g., color, size), full product descriptions, specifications, and other pertinent metadata associated with each candidate item.

The exploit module (e.g., detailed lookup) can employ a second Large Language Model (LLM) based agent, or an LLM specifically configured for the exploitation task. According to an embodiment, this LLM agent can be the same model as used in the explore module (e.g., partial lookup) but guided by different operational parameters or prompt engineering strategies, or it can be a distinct LLM, e.g., potentially a larger or more specialized model, optimized for nuanced comparative analysis and definitive decision-making.

According to an embodiment, prompt engineering for this phase can be specifically designed to instruct the LLM agent to perform a detailed examination of each candidate. Such prompts can direct the LLM to focus on specific product attributes, consider all available options, perform deeper comparisons between the candidates, and evaluate them rigorously against the explicit and implicit requirements of the user query.

As shown in Table III below, an example product page LEAP prompt template for the exploit module (e.g., detailed lookup) is provided based on a WebShop environment, but embodiments are not limited thereto.

TABLE III

| | |
|---|---|
| Prompt | Follow my instructions properly. |
| Template | You are a real world agent who is shopping on the web. |
| | Select for me ONE best product with matching options and features for |
| | “[Human_Instruction]″ |
| | The details of the products available on the web are as below in json format. |
| | Please select only best matching product_ids. |
| | { |
| | [Partial_lookup_response_Products] |
| | } |
| | Only return ONE of the selected best product's id. |
| Prompt | Follow my instructions properly. |
| Example | You are a real world agent who is hopping on the web. |
| | Select for me ONE best product with matching options and features for “black |
| | high quality cenglings womens cowl neck sweatshirt″. |
| | The details of the products available on the web are as below in json format. |
| | Please select only best matching product_ids. |
| | { |
| | ... |
| | “B09M472NR1″: { |
| | “title_price″: “JJSUnS Women's Warm Long Sleeve Jackets With |
| | Hood Full Zip Up Fall Winter Tie Waist Coats Hoodie Windproof Outwear ; |
| | Price: $28.99″, |
| | “options″: “size [small][medium][large][x-large]″, |
| | “attributes″: “long sleeve ; imported zipper ; light weight ; jacket |
| | women ; faux fur ; pullover hoodie ; loose fit ; daily wear ; slim fit ; fashion ; |
| | women's fashion hoodies & sweatshirts″, |
| | “description″: “Special V neck/High Neck/Crew Neck/U- |
| | Neck/Open Neck/Boat Neck/Scoop Neck/Leopard Print/Turtle Neck/Half Zip/- |
| | Cowl Neck design″ }, |
| | ... |
| | } |
| | Only return ONE of the selected best product's id. |

In addition, the LLM agent for the exploit module (e.g., detailed lookup) can perform an in-depth analysis of each shortlisted candidate. This can involve a detailed look-up where the agent thoroughly reviews and matches the user query against all available metadata for each candidate, including their detailed descriptions, attributes and options.

For example, in embodiments where the method operates within dynamic environments, such as interacting with e-commerce websites or other online platforms, the acquisition of detailed information for the exploit module's in-depth analysis can involve active data gathering by an automated agent (e.g., stage II, LEAN, discussed in more detail below).

According to an embodiment, this automated agent can be an integral part of the LLM agent within the exploit module or a distinct sub-module or tool directed thereby, or can replace the exploit module, which is configured to navigate to and interact with web pages associated with the shortlisted candidate items received from the explore module (e.g., partial lookup). This capability can allow the process to access comprehensive and up-to-date details that may not be present in an initial database or summary information.

The automated agent's web page navigation and interaction capabilities can include several functionalities. For instance, upon receiving a shortlisted item (e.g., identified by a URL or product ID), the agent can be configured to retrieve the corresponding product detail page. Once on such a page, the agent can programmatically identify and interact with various web page elements to unveil or specify product variations and collect associated data. This process can involve selecting options from drop-down menus (e.g., for attributes such as size, color, material, or configuration), clicking on radio buttons or checkboxes representing different choices, or even inputting data into specific fields if required to customize a product view. The agent can parse the Document Object Model (DOM) of the web page or utilize other web scraping and browser automation techniques to locate these interactive elements and extract the resulting information.

For example, as the automated agent interacts with these web page elements for each shortlisted item, the agent can systematically extract the pertinent detailed information. This can include, but is not limited to, variant-specific pricing, availability status for selected options, detailed specifications, customer reviews associated with particular configurations, images, and any other attributes or descriptive text that become visible or accessible as a result of these interactions.

This gathered information can then be compiled, structured, and associated with the respective candidate item. This rich, interactively-obtained dataset can form the comprehensive basis upon which the automated agent performs its detailed comparative analysis and makes its final selection.

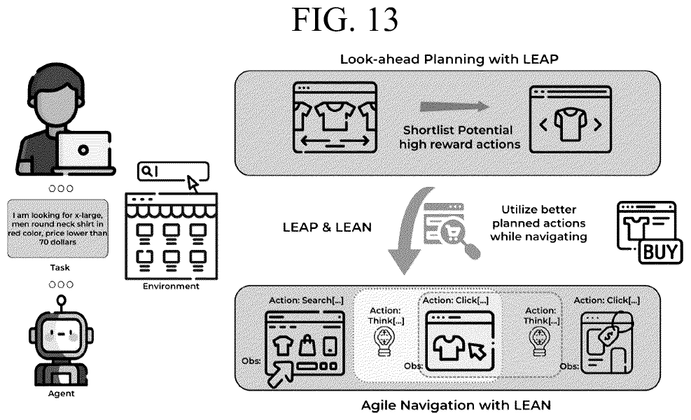

FIG. 13 illustrates an example of an autonomous agent performing tasks in a web shopping environment which incorporates both Look-ahead Planning (e.g., stage I, LEAP) and Agile Navigation (e.g., stage II, LEAN) according to an embodiment of the present disclosure.

As discussed above, according to an embodiment, the exploit module can be replaced with agile navigation by an automated agent (e.g., stage II, LEAN) in situations where navigation is desired (e.g., when full access to all information in a backend database is not available or in a situation of controlling a robot in a complex environment, etc.).

For example, FIG. 13 provides a flowchart illustrating an example embodiment of the method which can include an iterative, two-stage process (e.g., LEAP and LEAN) for controlling an autonomous AI agent to complete a navigational task within an interactive environment, according to an embodiment. The process can be repeated at each step of a task, up to a pre-determined step limit (e.g., S), ensuring a robust and efficient path to task completion.

According to an embodiment, the process can begin with the agent situated in an environment (e.g., I) with a given task such as “I am looking for x-large men round neck shirt in red color, price lower than 70 dollars.” At each step in the process, the agent can first perform a planning stage to identify viable actions (e.g., stage I, LEAP), and then a navigation stage (e.g., stage II, LEAN) to select and execute the next, single best action.

The first stage of each iteration can be the Look-ahead Planning (LEAP) phase. The objective of this stage is to intelligently reduce the entire set of all possible actions available in the current state (e.g., the action space) to a smaller, manageable short-list of promising, high-potential actions. For example, the agent can virtually explore the immediate outcome of each possible action and obtain corresponding observations. The LLM agent can analyze these potential action-observation pairs and select a sub-set of actions that are most likely to advance the overall task.

This planning stage (e.g., explore phase) can effectively filter out irrelevant or low-utility actions, solving the problem of an overwhelmingly large action space and allowing the agent to focus its more detailed reasoning on only the most viable options. According to an embodiment, this planning stage can include a search phase and an explore phase, as discussed above with reference to FIG. 8, but embodiments are not limited thereto. For example, the planning stage can include just an explore phase, according to an embodiment.

Further in this example, after generating the short-list of promising, high-potential actions, the process can proceed to stage II (e.g., Agile Navigation with LEAN). This stage (e.g., stage II) can take the short-list of high-potential actions from the LEAP phase (e.g., stage I) as its primary input.

For example, the objective of the LEAN phase is to apply a deeper, more nuanced logic to select the single best action from the short-list. This can be accomplished through a unique two-step reasoning process. First, the LLM agent can generate a textual reason that provides a logical justification for selecting a subsequent action based on the overall task description and the available high-potential actions. Second, the agent can then use this explicit reason along with the task description and the action list to determine and execute the single, optimal next action.

This reason based selection can help ensure that the agent's actions are viable and logically consistent with the goals of the task, thereby preventing navigational errors and inefficient paths. For example, this can provide an reasoning trace which can be a textual sentence generated by the LLM agent explaining why it selected a particular action as the optimal choice in a given context.

By generating this reasoning trace before acting, the agent's decisions can be guided by a structured, logical process rather than by simple prediction alone, which can significantly improve its ability to follow a coherent strategy and successfully complete complex, multi-step tasks.

Further in this example, following the execution of the next action, the agent can check if the task's final state has been reached (e.g., buy shirt). If not, the entire two-stage process can be repeated from the new state of the environment. This iterative application of planning (LEAP) and reason based navigating and acting (LEAN) provides a powerful and efficient method for guiding an autonomous agent through complex, multi-step tasks.

As shown in Table IV below, an example algorithm for the method is provided, but embodiments are not limited thereto.

TABLE IV
Algorithm 1 LEAP & LEAN Methodology

| | Input: |
|---|---|
| | Task T with description d_{T} |
| | LLM agent [symbol] |
| | Environment E producing observations (∈ |
| | [symbol] ) upon receiving actions (∈ [symbol] ) |
| | Pre-determined step limit S |
| | Output: |
| | Task success rate r for task T |
| 1: | Set environment E for task T |
| 2: | i := 0 |
| 3: | while i ≤ S do |
| 4: | Let the possible action-space be Aᵢ |
| 5: | [symbol] Stage I: Look-ahead Planning |
| 6: | Initialize potential actions, Aₚ ← [ ] |
| 7: | Collect all action-observation pairs |
| 8: | for each action a in Aᵢ do |
| 9: | pairs ← (a, o) where o ← E(a) |
| 10: | end for |
| 11: | Agent selects potential high reward actions |
| 12: | Aₚ ← [symbol] (d_{T}, pairs) |
| 13: | [symbol] Stage II: Agile Navigation with Planning |
| 14: | Generate reason to act while navigating |
| 15: | reason ← [symbol] (d_{T}, Aₚ) |
| 16: | Use reason to find optimal next action |
| 17: | aₙₑₓₜ ← [symbol] (d_{T}, Aₚ, reason) |
| 18: | if aₙₑₓₜ Corresponds to final state then |
| 19: | Calculate r |
| 20: | return r |
| 21: | end if |
| 22: | i := i + 1 |
| 23: | end while |
| 24: | return 0 |

For example, according to an embodiment, Algorithm 1, as illustrated in Table IV, provides a detailed, step-by-step logical flow for a method including LEAP and LEAN. The algorithm can control an autonomous LLM agent (/.) to complete a task (7) within an interactive environment (E). The process is iterative, designed to execute a sequence of actions up to a pre-determined step limit(S), and outputs a task success rate (r).

Regarding the first stage of each iteration (e.g., detailed in lines 5 through 12), is the Look-ahead Planning (LEAP) phase. The objective of this stage is to intelligently reduce the total set of all possible actions in the possible action-space (Aᵢ) to a manageable short-list of high-potential actions (Aₚ).

The process can begin by initializing an empty set for potential actions (Aₚ, line 6). Then, a for loop (e.g., lines 8-10) can be executed for each action a in the current action-space (Aᵢ).

Within this for loop, the agent can collect all possible action-observation pairs by determining the resulting observation o for each action a. Once all pairs are collected, the LLM agent (L) can select a sub-set of potential high-reward actions from all the possibilities (line 12).

For example, this planning stage can effectively filter out irrelevant or low-utility actions, in order to allow the subsequent navigation stage to operate on a much more focused and relevant set of choices.

Regarding the second stage of the iteration (e.g., detailed in lines 13 through 17), is the Agile Navigation (LEAN) phase. This stage can take the short-list of high-potential actions (Aₚ) from the LEAP phase as a primary input.

The objective of the LEAN phase is to apply a more nuanced, reason-based logic to select the single, optimal next action. This is accomplished in a two-step process.

For example, as shown in lines 14 and 15, the LLM agent can generate a textual reason that provides a logical justification for acting. For example, this reason can be generated based on the overall task description (d_{T}) and the available high-potential actions (Aₚ).

According to an embodiment, the inputs of the generating the reason phase can include the system prompt (pₛ) with the original user query, the previous action-observation pair (aᵢ₋₁, oᵢ₋₁), the short list of actions/choices (Aₚ) provided by the LEAP stage, and an in-context example (Inᵢ₋₁), and the output is the generated reason (e.g., explained in more detail below regarding the discussion of example prompts).

The in-context example can be a sample demonstration provided within the prompt to the LLM agent to guide its behavior and illustrate the desired output format. This example can include a complete or partial transcript of a similar, successfully completed task or sub-task, showing a sequence of observations, reasoning traces, and corresponding actions. It can function as a form of one or few-shot learning, conditioning the model to understand the expected structure and style of a logical thought process for the specific environment it is navigating.

For instance, the in-context example can show the model what a well-formed reasoning trace looks like and how it logically connects to a subsequent action. By providing this template of success, the agent can more reliably generate its own valid, contextually appropriate reasoning traces and actions when faced with a new, unseen state in its current task, thereby improving its navigational accuracy and efficiency.

Further, as shown in lines 16 and 17, the agent can use this explicit reason along with the task description and the action list to determine the single, optimal next action (aₙₑₓₜ). This reason based selection can help ensure that the agent's actions are logically consistent with the goals of the task.

Following the determination of the next action (aₙₑₓₜ), the agent can then execute the action. According to an embodiment, the inputs of the executing the next action phase can include the system prompt (pₛ) with the original user query, the previous action-observation pair (aᵢ₋₁, Oᵢ₋₁), the short list of actions/choices (Aₚ) provided by the LEAP stage, and another in-context example (Inᵢ₋₁), and the generated reason.

Also, according to an embodiment, the in-context examples can be selected with matching logic, such as selecting from among a search response example, a click response example, and a think response example (which are discussed in more detail at a later section below). Also, the in-context example included in the prompt can provide the trigger for allowing the agent to determine whether the generate reason for selecting next action phase is to be executed or the execute the next action phase is to be executed.

Further, a check can be performed (e.g., line 18) to determine if this action corresponds to the final state of the task. According to an embodiment, explicit matching can be performed for this check (e.g., matching for a buy now action, etc.). If it does, then the success rate r can be calculated and returned (e.g., lines 19-21), terminating the process. If not, the step counter i is incremented (e.g., line 22), and the entire two-stage process can be repeated from the new state of the environment. If the loop completes without reaching the final state, a value of 0 is returned (e.g., line 24), indicating task failure.

In more detail, the LEAN phase is designed to enhance the performance of LLMs of varying sizes (e.g., especially smaller LLMs), which often struggle to process the full action space and in-context examples efficiently, leading to hallucinated actions when faced with excessive context.

To address this, the LEAN stage can employ a selective prompting strategy that can utilize only the most meaningful segments from the overall context (C={d_{T}, (ar, Oᵣ, âₜ, δₜ)| t∈Z₊}) at each decision point, rather than relying on the complete context which may overwhelm the agent or exceed the context window. During this stage, a reasoning trace (reason) and the next action (aₙₑₓₜ) can be generated, with actions selected from a pool of high-potential candidates (Aₚ) identified in the earlier LEAP stage.

Further, LEAN's segment selection strategy can be applied to both reasoning trace generation and action generation. Relevant segments can be derived using approaches such as heuristics or retrieval. According to an embodiment, heuristics can be employed due to their simplicity and low computational overhead.

In addition, segment curation can be applied to both in-context examples and the current task context, providing a carefully curated subset of examples alongside highly relevant subsections of task progress during each action generation phase. This dual simplification of the prompt can enhance its clarity, making it easier for instruction-following LLMs to comprehend and respond effectively.

Overall, the LEAP stage can explore the full action-space to identify potential high reward actions while the LEAN stage can construct clear concise prompts for efficient navigation. Their integration can effectively decouple the tasks of planning and navigation, preventing the LLM from being overwhelmed by excessive exploration and overthinking, thereby enhancing goal achievement efficiency.

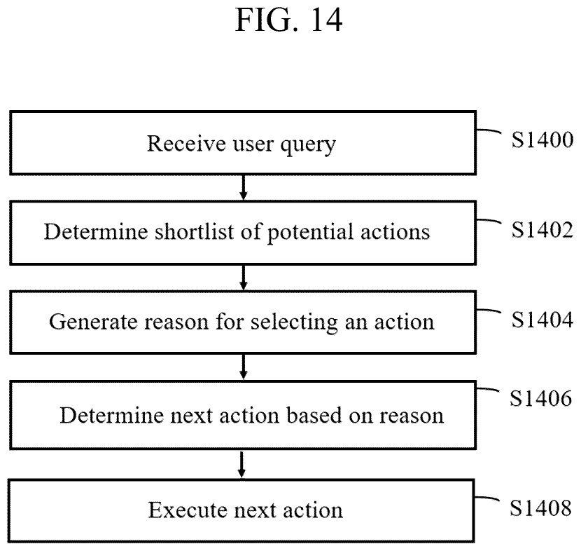

FIG. 14 shows an example flow chart of a method according to an embodiment of the present disclosure. For example, according to an embodiment, a method for controlling an AI device can include receiving a user query corresponding to a task (e.g., S1400), determining, by a first large language model (LLM) based component corresponding to a look-ahead planning phase, a shortlisted set of potential actions from a plurality of available actions available based on a current state of an interactive environment (e.g., S1402), generating, by a second LLM based component corresponding to an agile navigation phase, a textual reason for selecting an action from the shortlisted set of potential actions (e.g., S1404), determining, by the second LLM based component, a single optimal next action from the shortlisted set of potential actions based on the textual reason (e.g., S1406), and executing the single optimal next action to transition the interactive environment to a new state (e.g., S1408).

Table V below shows an example of a system prompt (pₛ) that can be used at the beginning of the prompt for stage II (LEAN) in a WebShop environment.

TABLE V
You are a web shopping agent.
Follow the illustration and perform in similar fashion to buy some product.
Make sure RESPONSE is in either of the format only \newline
* search[RESPONSE]
* click[RESPONSE]
* think[RESPONSE]

For example, the system prompt (pₛ) can function as a high level directive that establishes and defines the expected behavior of the LLM agent. It can instruct the agent to act as a web shopping agent in navigating a web shopping environment whose goal is to complete a given task (e.g., such as purchasing a blue t-shirt, etc.).

In this example system prompt (pₛ), search [RESPONSE], click [RESPONSE], and think [RESPONSE] are the three formatted commands that the AI agent can use, but embodiments are not limited thereto. For example, they are the agent's vocabulary for action. Also, depending on the selected response a corresponding in-context example chunk can be provided to the agent.

For example, the search [RESPONSE] command can be utilized by the agent to input text into a designated field, such as a search bar, where the response parameter contains the string of text to be entered. The click [RESPONSE] command can be utilized to interact with any selectable element on the page, such as a button, link, dropdown menu or image, where the response parameter contains a description of the target element. These commands represent the agent's means of manipulating the state of the interactive environment and progressing through the steps of a navigational task.

Table VI below shows an example of an in-context example chunk used by LEAN for a “Search” action in Webshop.

TABLE VI
WebShop
Instruction:
i would like a 3 ounce bottle of bright citrus deodorant for sensitive skin,
and price lower than 50.00 dollars \newline
[Search]
Action: Search[3 ounce bright citrus deodorant sensitive skin]

Table VI illustrates an example in-context example chunk used within a prompt to guide the LLM agent's action generation process during the LEAN phase when the agent decides to execute a search action.

Table VII below shows an example of an in-context example chunk used by LEAN for reasoning after a “Search” action in Webshop.

TABLE VII
WebShop
Instruction:
i would like a 3 ounce bottle of bright citrus deodorant for sensitive skin, and
price lower than 50.00 dollars
[Search]
Action: Search[3 ounce bright citrus deodorant sensitive skin]
Observation:
[Back to Search]
Page 1 (Total results: 50)
[Next >]
[B078GWRC1J]
Bright Citrus Deodorant by Earth Mama | Natural and Safe for Sensitive Skin,
Pregnancy and Breastfeeding, Contains Organic Calendula 3-Ounce
$10.99
[B078GTKVXY]
Ginger Fresh Deodorant by Earth Mama | Natural and Safe for Sensitive Skin,
Pregnancy and Breastfeeding, Contains Organic Calendula 3-Ounce
$10.99
[B08KBVJ4XN]
Barrel and Oak - Aluminum-Free Deodorant, Deodorant for Men, Essential Oil-Based
Scent, 24-Hour Odor Protection, Cedar & Patchouli Blend, Gentle on Sensitive Skin (
Mountain Sage, 2.7 oz, 2-Pack)
$15.95
Action: think[B078GWRC1J and B078GTKVXY are bright citrus deodorant less then 50
dollars. I can check B078GWRC1J first.]

For example, the in-context example chunk in Table VII teaches the LEAN agent how to handle a search results page that contains multiple, different types of items. The example shows the agent how to generate a reason that states a clear, logical justification for its subsequent action of clicking on the correct item, e.g., “B078GWRCIJ.”

Table VIII below shows an example of an in-context example chunk used by LEAN for a “Click” action in Webshop.

TABLE VIII
WebShop
Instruction:
i would like a 3 ounce bottle of bright citrus deodorant for sensitive skin, and
price lower than 50.00 dollars
[Search]
Action: Search[3 ounce bright citrus deodorant sensitive skin]
Observation:
[Back to Search]
Page 1 (Total results: 50)
[Next >]
[B078GWRC1J]
Bright Citrus Deodorant by Earth Mama | Natural and Safe for Sensitive Skin,
Pregnancy and Breastfeeding, Contains Organic Calendula 3-Ounce
$10.99
[B078GTKVXY]
Ginger Fresh Deodorant by Earth Mama | Natural and Safe for Sensitive Skin,
Pregnancy and Breastfeeding, Contains Organic Calendula 3-Ounce
$10.99
[B08KBVJ4XN]
Barrel and Oak - Aluminum-Free Deodorant, Deodorant for Men, Essential Oil-Based
Scent, 24-Hour Odor Protection, Cedar & Patchouli Blend, Gentle on Sensitive Skin (
Mountain Sage, 2.7 oz. 2-Pack)
$15.95
Action: think[B078GWRC1J and B078GTKVXY are bright citrus deodorant less then 50
dollars. I can check B078GWRC1J first.]
Observation: OK.
Action: click[B078GWRC1J]

For example, the in-context example chunk in Table VIII teaches the LEAN agent how to click an item based on the user query and previous action-observation pair.

Table IX below shows an example of an in-context example chunk used by LEAN for reasoning after a “Click” action in Webshop.

TABLE IX
WebShop
Instruction:
i would like a 3 ounce bottle of bright citrus deodorant for sensitive skin, and
price lower than 50.00 dollars
[Search]
Action: click[B078GWRC1J]
Observation:
[Back to Search]
[< Prev]
scent [assorted scents][bright citrus][calming lavender][ginger fresh][simply non-
scents]
size [travel set (4-pack)][3 ounce (pack of 1)][3-ounce (2-pack)]
Bright Citrus Deodorant by Earth Mama | Natural and Safe for Sensitive Skin,
Pregnancy and Breastfeeding, Contains Organic Calendula 3-Ounce
Price: $10.99
Rating: N.A.
[Description]
[Features]
[Reviews]
[Buy Now]
Action: think[For 3 ounce bottle of bright citrus deodorant for sensitive skin, the
item has options ‘bright citrus' and ‘3 ounce (pack of 1)’ end seems good to buy.]

For example, the in-context example chunk in Table IX teaches the LEAN agent how to think and generate a reason for deciding a next action after having performed a click action based on the user query and previous action-observation pair.

Table X below shows an example of an in-context example chunk used by LEAN for a “Buy Now” action in Webshop.

TABLE X
WebShop
Instruction:
i would like a 3 ounce bottle of bright citrus deodorant for sensitive skin, and
price lower than 50.00 dollars
[Search]
Action: click[B078GWRC1J]
Observation:
[Back to Search]
[< Prev]
scent [assorted scents][bright citrus][calming lavender][ginger fresh][simply non-
scents]
size [travel set (4-pack)][3 ounce (pack of 1)][3-ounce (2-pack)]
Bright Citrus Deodorant by Earth Mama | Natural and Safe for Sensitive Skin,
Pregnancy and Breastfeeding, Contains Organic Calendula 3-Ounce
Price: $10.99
Rating: N.A.
[Description]
[Features]
[Reviews]
[Buy Now]
Action: think[For 3 ounce bottle of bright citrus deodorant for sensitive skin, the
item has options ‘bright citrus' and ‘3 ounce (pack of 1)’ and seems good to buy.]
Observation: OK.
Action: click[Buy Now]

For example, the in-context example chunk in Table X teaches the LEAN agent how to perform a buy now action based on the user query and previous action-observation pair.

However, shopping on an website is only one example, but embodiments are not limited thereto. For example, the method can be applied to other types of environments, according to embodiments.

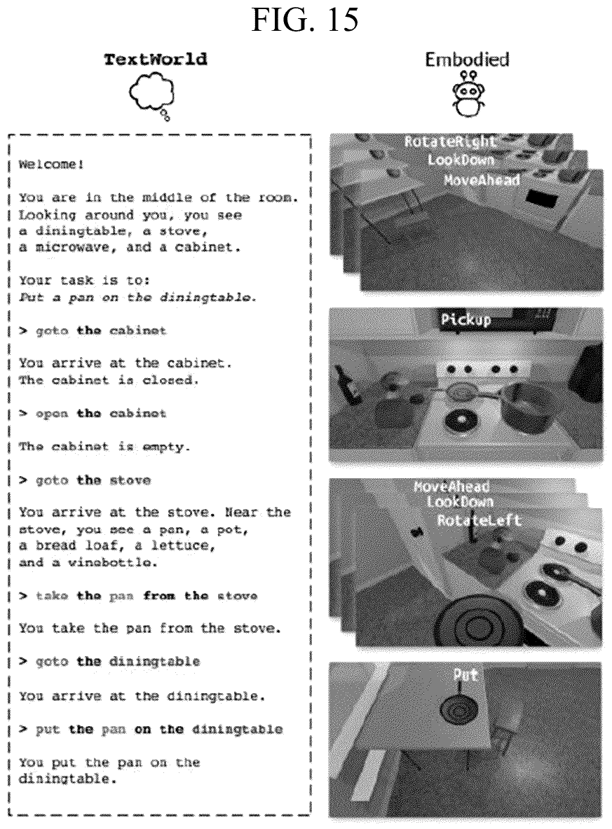

FIG. 15 shows an example of applying the method to a robot navigating an household environment (e.g., simulated by AlfWorld), according to an embodiment.

According to an embodiment, the method can be applied to a robot navigating a household environment to complete complex physical manipulation tasks. For a high-level task such as “Put a pan on the dining table,” the agent can execute a series of iterative steps to achieve the goal.

For example, at each state, such as standing in the kitchen, the look-ahead planning (LEAP) phase (stage I) can first identify a short-list of high-potential actions (e.g., open cabinet, look on stove, take pan). Then, the agile navigation (LEAN) phase (stage II) can generate a specific reasoning trace (e.g., “to acquire the pan, I must first take it from the stove”) to select the single, optimal next action from that list.

This iterative process of planning and reason-based action selection can continue as the agent navigates from the kitchen to the dining table and places the pan to complete complex, multi-step physical or simulated objectives.

Table XI below shows an example of a system prompt (pₛ) that can be used at the beginning of the prompt for stage II (LEAN) in a robot navigating an household environment.

TABLE XI
ALFWorld
Interact with a household to solve a task. You should do thinking and acting
periodically.
You need to generate actions that strictly follow the below templates:
1. goto [location] 2. take [object] from [location] 3. put [object] in/on [location]
3. open [something] 4. close [something] 5. toggle [object][location]
6. clean [object] with [something] 7. heat [object] with [receptacle] 8. cool [
object] with [receptacle]
If Nothing happens, try another action or think about possible alternatives.
Avoid exploring, go to, open, examine actions of the same locations or items over
and over again.

For example, the system prompt (pₛ) can instruct the agent to act as or control a robot navigating a household environment whose goal is to complete a given task.

In this example system prompt (pₛ), goto [location], take [object] from [location], put [object] in/on [location], open [something], close [something], toggle [object] [location], clean [object] with [something], heat [object] with [receptacle], and cool [object] with [receptacle] and are the eight example commands that the AI agent can use, but embodiments are not limited thereto. Also, depending on the selected action a corresponding in-context example chunk can be provided to the agent.

Table XII below shows an example of an in-context example chunk used by LEAN for a “Finding object” action in a robot navigating an household environment.

TABLE XII
You are in the middle of a room. Looking quickly around you, you see a cabinet 4, a
cabinet 3, a cabinet 2, a cabinet 1, a countertop 1, a garbagecan 1, a
handtowelholder 2, a handtowelholder 1, a sinkbasin 2, a sinkbasin 1, a toilet 1, a
toiletpaperhanger 1, and a towelholder 1.
Your task is to: put some spraybottle on toilet.,
> think: To solve the task, I need to find and take a sparybottle, then put it on
toilet.
OK.
> think: First I need to find a spraybottle. A spraybottle is more likely to appear
in cabinet (1-4), countertop (1), toilet (1), sinkbasin (1-2), garbagecan (1). I can
check one by one, starting with cabinet 1.
OK.
> go to cabinet 1
On the cabinet 1, you see a cloth 1, a soapbar 1, a soapbottle 1.
> go to cabinet 2
The cabinet 2 is closed.
> open cabinet 2
You open the cabinet 2. The cabinet 2 is open. In it, you see a candle 1 and a
spraybottle 2.

Table XII illustrates an example in-context example chunk used within a prompt to guide the LLM agent's reasoning and generating a next action during the LEAN phase when the agent decides to execute a Finding object action.

Table XIII below shows an example of an in-context example chunk used by LEAN for a “Picking up object” action in a robot navigating an household environment.

TABLE XIII
You are in the middle of a room. Looking quickly around you, you see a cabinet 4, a
cabinet 3, a cabinet 2, a cabinet 1, a countertop 1, a garbagecan 1, a
handtowelholder 2, a handtowelholder 1, a sinkbasin 2, a sinkbasin 1, a toilet 1, a
toiletpaperhanger 1, and a towelholder 1.
Your task is to: put some spray bottle on toilet.
> think: Now I find a spraybottle (2). Next, I need to take it.
OK.
> take spraybottle 2 from cabinet 2
You pick up the spraybottle 2 from the cabinet 2.

Table XIII illustrates an example in-context example chunk used within a prompt to guide the LLM agent's reasoning and generating a next action during the LEAN phase when the agent decides to execute a Picking up object action.

Table XIV below shows an example of an in-context example chunk used by LEAN for a “Put down an object” action in a robot navigating an household environment.

TABLE XIV
You are in the middle of a room. Looking quickly around you, you see a cabinet 4, a
cabinet 3, a cabinet 2, a cabinet 1, a countertop 1, a garbagecan 1, a
handtowelholder 2, a handtowelholder 1, a sinkbasin 2, a sinkbasin 1, a toilet 1, a
toiletpaperhanger 1, and a towelholder 1.
Your task is to: put some spraybottle on toilet.
> think: Now I take a spraybottle (2). Next, I need to put it in/on toilet 1.
OK.
> go to toilet 1
On the toilet 1, you see a soapbottle 2.
> put spraybottle 2 in/on toilet 1
You put the spraybottle 2 in/on the toilet 1.

Table XIV illustrates an example in-context example chunk used within a prompt to guide the LLM agent's reasoning and generating a next action during the LEAN phase when the agent decides to execute a put down an object action.

Table XV below shows an example of an in-context example chunk used by LEAN for a “Clean an object” action in a robot navigating an household environment.

TABLE XV
You are in the middle of a room. Looking quickly around you, you see a cabinet 13, a
cabinet 12, a cabinet 11, a cabinet 10, a cabinet 9, a cabinet 8, a cabinet 7, a
cabinet 6, a cabinet 5, a cabinet 4, a cabinet 3, a cabinet 2, a cabinet 1, a
coffeemachine 1, a countertop 1, a diningtable 1, a drawer 1, a fridge 1, a
garbagecan 1, a microwave 1, a shelf 3, a shelf 2, a shelf 1, a sinkbasin 1, a
stoveburner 4, a stoveburner 3, a stoveburner 2, a stoveburner 1, and a toaster 1.
Your task is to: put a clean lettuce in diningtable.
> think: Now I take a lettuce (1). Next, I need to go to sinkbasin (1) and clean it.
> go to sinkbasin 1
On the sinkbasin 1, you see a apple 2, a ladle 2, a spoon 1, and a tomato 3.
> clean lettuce 1 with sinkbasin 1
You clean the lettuce 1 using the sinkbasin 1.

Table XV illustrates an example in-context example chunk used within a prompt to guide the LLM agent's reasoning and generating a next action during the LEAN phase when the agent decides to execute a clean an object action.

Table XV below shows an example of an in-context example chunk used by LEAN for a “Cool an object” action in a robot navigating an household environment.

```
TABLE XV
You are in the middle of a room. Looking quickly around you, you see a cabinet 16, a
  cabinet 15, a cabinet 14, a cabinet 13, a cabinet 12, a cabinet 11, a cabinet 10, a
  cabinet 9, a cabinet 8, a cabinet 7, a cabinet 6, a cabinet 5, a cabinet 4, a
cabinet 3, a cabinet 2, a cabinet 1, a coffeemachine 1, a countertop 2, a countertop
  1, a diningtable 1, a drawer 5, a drawer 4, a drawer 3, a drawer 2, a drawer 1, a
fridge 1, a garbagecan 1, a microwave 1, a safe 1, a sinkbasin 1, a stoveburner 4, a
  stoveburner 3, a stoveburner 2, a stoveburner 1, and a toaster 1.
Your task is to: cool some pan and put it in stoveburner.
> think: Now I take a pan (1). Next, I need to go to a fridge (1) and cool it.
OK.
> go to fridge 1
The fridge 1 is closed.
> cool pan 1 with fridge 1
You cool the pan 1 using the fridge 1.
```

Table XV illustrates an example in-context example chunk used within a prompt to guide the LLM agent's reasoning and generating a next action during the LEAN phase when the agent decides to execute a cool an object action.

Table XVI below shows an example of an in-context example chunk used by LEAN for a “Heat an object” action in a robot navigating an household environment.

```
TABLE XVI
You are in the middle of a room. Looking quickly around you, you see a cabinet 10, a
  cabinet 9, a cabinet 8, a cabinet 7, a cabinet 6, a cabinet 5, a cabinet 4, a
cabinet 3, a cabinet 2, a cabinet 1, a coffeemachine 1, a countertop 3, a countertop
  2, a countertop 1, a diningtable 1, a drawer 6, a drawer 5, a drawer 4, a drawer 3,
  a drawer 2, a drawer 1, a fridge 1, a garbagecan 1, a microwave 1, a sinkbasin 1, a
  stoveburner 4, a stoveburner 3, a stoveburner 2, a stoveburner 1, and a toaster 1.
Your task is to: heat some egg and put it in diningtable.
> think: Now I take an egg (2). Next, I need go to a microwave (1) and heat it.
OK.
> go to microwave 1
The microwave 1 is closed.
> heat egg 2 with microwave 1
You heat the egg 2 using the microwave 1.
```

Table XVI illustrates an example in-context example chunk used within a prompt to guide the LLM agent's reasoning and generating a next action during the LEAN phase when the agent decides to execute a heat an object action.

For example, this agile prompting strategy within the LEAN phase can enhance the performance and efficiency of the LLM agent, particularly when using more resource-constrained or efficient LLMs (eLLMs). Unlike related-art methods that may provide a large, static prompt containing numerous examples for every possible contingency in a task, this agile prompting method utilizes dynamically selected, chunked in-context examples.

For example, this means that at each step, the agent can be provided with only a small, highly relevant example or few examples that pertain directly to its current situation (e.g., an example for handling a search results page is only provided when the agent is on a search results page). This approach can keep the overall context size minimal, which directly addresses the context length limitations inherent in many eLLMs and helps ensure that the most valuable information is not truncated or lost.

In addition, this agile prompting strategy provides several further advantages by mitigating common failure modes in autonomous agents. By providing only a minimal, relevant portion of context, the method can reduce the likelihood of agent confusion and hallucinations, as there is less irrelevant information to distract the model or cause it to suggest inappropriate actions.

Further, this approach can prevent progress disorientation, in which an agent provided with a full task script might misunderstand its current position in the sequence. The condensed, situational context helps to keep the agent focused on the immediate sub-task. This overall context condensation also reduces the computational resources required for the LLM to process the prompt at each step, leading to lower latency and making the agent more suitable for deployment on edge devices with limited memory and processing power.

Various experiments were carried out against related art models to evaluate the results.

As shown in Table XVII below, the AI model according to embodiments outperforms other related-art methods.

TABLE XVII

| | |
|---|---|
| Task Score | Success Rate |

WebShop environment

| | | |
|---|---|---|
| Rule-based | 44.8 | 9.2 |

Learning-based baseline models

| | | |
|---|---|---|
| IL | 60.4 | 28.0 |
| IL + RL | 62.4 | 28.7 |

Open-source LLM - Gemma-2-9B

| | | |
|---|---|---|
| ReAct | 13.1 | 4.0 |
| LEAP | 63.1 | 27.4 |
| LEAN | 45.0 | 25.8 |
| LEAP & LEAN | 50.8 | 27.6 |

API-based LLM - Gemini

| | | |
|---|---|---|
| ReAct | 35.4 | 21.8 |
| LEAP | 70.4 | 42.8 |
| LEAN | 53.6 | 35.0 |
| LEAP & LEAN | 62.6 | 44.0 |
| Human Expert | 82.1 | 59.6 |

As shown above, drawing upon the experimental evaluations conducted in the WebShop environment, a synthetic online shopping platform containing a large database of items and user instructions, the efficacy of the disclosed framework for autonomous agents performing planning and reasoning was empirically demonstrated. Using Task Score and Success Rate metrics to measure performance, it was shown that the method, employing look-ahead planning (LEAN) and agile navigation (LEAN), significantly improved performance compared to the ReAct strategy.

For example, with the Gemma-2-9B agent, the method achieved a Task Score of 50.8% and a Success Rate of 27.6%, markedly surpassing ReAct's scores of 13.1% and 4.0% respectively. Similar performance trends were observed when evaluating with the Gemini model. These results underscore that the proposed framework, through phases of look-ahead planning with agile navigation effectively enhances the planning and reasoning capabilities of LLM-based autonomous agents in complex task-oriented domains.

According to an embodiment, the AI device 100 can be configured with the method can achieve improved agent processing efficiency and enhance the navigational accuracy and overall success rate of task completion. The AI device 100 can be used in various types of different situations.

According to one or more embodiments of the present disclosure, the AI device 100 can solve one or more technological problems in the existing technology, such as strategically integrating different processing stages within an iterative workflow. This can include an initial look-ahead planning phase (LEAP) to efficiently identify a manageable set of high-potential actions from a current environment, and a subsequent agile navigation phase (LEAN) that employs explicit, LLM-generated reasoning to select the single optimal action from that set. This two-stage process can optimize resource utilization and enhance the scalability and accuracy of AI-driven agents in navigational and sequential tasks, thereby providing a more practical and powerful solution for assisting users.

For example, embodiments of the LEAP method can provide numerous advantages over conventional systems for AI-driven navigational task completion, particularly those relying on monolithic or less structured approaches. The method can provide improved efficiency and reduced computational cost, especially when compared to systems that might employ a single, complex Large Language Model (LLM) to both plan and execute an action in one undifferentiated step. By segmenting the decision-making process at each step into two distinct phase (e.g., first using a computationally efficient look-ahead planning (LEAP) phase to shortlist high-potential actions, and then engaging a more focused agile navigation (LEAN) phase to select the optimal action based on a generated reason) the method can optimize resource utilization. This architectural design also contributes to enhanced scalability and logical consistency, which can be highly effective for tasks involving long action sequences or complex, branching paths within dynamic environments such as interactive websites, software applications, or physical spaces.

Further, the method can offer practical applicability by its ability to leverage existing pre-trained LLMs for its agent functionalities, potentially obviating the need for extensive, resource-intensive new model training or task-specific fine-tuning for each deployment.

In addition, the structured, multi-stage process in the LEAP and LEAN framework can lead to better task completion accuracy. The systematic and more effective narrowing of options (e.g., form broad filtering in the database search phase, to semantic shortlisting in the explore phase, and culminating in meticulous analysis in the exploit phase) can help ensure that the decision-making is both thorough and focused on the most pertinent candidates at each step of completing a complex task. This methodology can facilitate successful task completion in fewer steps that are more closely aligned with user intent and requirements.

Also, an additional advantage is the flexibility in configuring different LLMs or specialized AI agents for the distinct stages of the iterative workflow. For example, a computationally leaner LLM can be employed for the initial look-ahead planning (LEAP) phase to efficiently and rapidly generate a short-list of high-potential actions from the environment. Then, a more powerful or domain-specific LLM can be reserved for the agile navigation (LEAN) phase, which can provide a more nuanced understanding to generate a coherent reasoning trace and select the single optimal next action. This adaptability allows for a tailored optimization of performance and resource allocation across the various components of the system, further contributing to its overall effectiveness in complex navigational tasks.

Also, according to an embodiment, the AI device 100 configured with the AI model can be used in a mobile terminal, a smart TV, a home appliance, a robot, an infotainment system in a vehicle, etc.

For example, the AI device 100 can be applied in a wide range of interactive applications including a digital assistant, a question and answering system, and a home robot. For example, according to an embodiment, the home robot can determine the user's intent and based on this information, the robot can perform a more relevant helping or caring action, or provide a better response or information that more accurately addresses the user's needs.

In addition, the framework's structured, multi-stage methodology for efficient information processing and decision-making allows for its application in diverse real-world contexts. In e-commerce and online shopping, for example, the method can enhance product recommendation and selection from vast online catalogs by systematically filtering numerous options and then performing detailed analysis on the most promising candidates using its phased approach. Similarly, in travel planning, the framework can assist users in selecting optimal flights, hotels, or itineraries by efficiently managing and comparing numerous choices based on user preferences through its structured evaluation process.

Furthermore, the method can be beneficial in various information-centric domains. For information retrieval, the framework can be adapted to efficiently locate specific documents or data within large corpora by employing its phased approach for initial broad searching followed by more targeted, LLM-driven analysis.

Also, in customer support applications, the method can effectively guide users to the most relevant help articles or solutions from extensive knowledge bases, thereby improving support efficiency.

More broadly, the principles of the method extend to many other potential applications where any multi-stage filtering, analysis, and selection process or action execution is advantageous for achieving accurate and efficient task completion or decision support in complex environments with numerous options.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor in the AI device, a user query corresponding to a task;
determining, by a first large language model (LLM) based component corresponding to a look-ahead planning phase, a shortlisted set of potential actions from a plurality of available actions available based on a current state of an interactive environment;
generating, by a second LLM based component corresponding to an agile navigation phase, a textual reason for selecting an action from the shortlisted set of potential actions;
determining, by the second LLM based component, a single optimal next action from the shortlisted set of potential actions based on the textual reason; and
executing, by the processor, the single optimal next action to transition the interactive environment to a new state.

2. The method of claim 1, further comprising:
iteratively repeating the determining the shortlisted set of potential actions, the generating the textual reason, the determining the single optimal next action, and the executing the single optimal next action until the task is completed.

3. The method of claim 2, wherein the iteratively repeating terminates upon one of the interactive environment reaching a final state corresponding to task completion or a predefined step limit being reached.

4. The method of claim 1, wherein the generating the textual reason includes:
dynamically selecting an in-context example chunk from among a plurality of in-context example chunks based on a relevance of the in-context example chunk to the current state of the interactive environment, wherein the in-context example chunk includes a template for a successful interaction including at least an example previous action-observation pair and an example textual reason; and
providing a prompt including the in-context example chunk to the second LLM based component for generating the textual reason.

5. The method of claim 1, wherein the determining the single optimal next action includes:
dynamically selecting an in-context example chunk from among a plurality of in-context example chunks based on a relevance of the in-context example chunk to the current state of the interactive environment, wherein the in-context example chunk includes a template for a successful interaction including at least an example previous action-observation pair, the textual reason and an example determined next action; and
providing a prompt including the in-context example chunk to the second LLM based component for determining the single optimal next action.

6. The method of claim 1, wherein the determining the shortlisted set of potential actions includes analyzing, by the first LLM based component, a plurality of action-observation pairs, each of the plurality of action-observation pairs corresponding to one of the plurality of available actions and a corresponding resulting observation in the interactive environment.

7. The method of claim 6, wherein the analyzing the plurality of action-observation pairs is based on a reward model configured to score the potential actions based on a predicted utility for advancing the task.

8. The method of claim 1, wherein the first LLM based component and the second LLM based component are based on different LLM models.

9. The method of claim 1, wherein the interactive environment is a web-based shopping environment, a household environment, or a software application interface.

10. The method of claim 1, wherein the single optimal next action includes an automated action on behalf of a user, the automated action including at least one of initiating a purchase transaction for a product, booking a reservation, and controlling a robotic device.

11. The method of claim 1, wherein the textual reason is part of a reasoning trace, the reasoning trace including a textual output from the second LLM based component that articulates a logical justification for selecting the single optimal next action for ensuring the single optimal next action is consistent with a coherent strategy for completing the task.

12. An artificial intelligence (AI) device, comprising:
a memory configured to store agent based prompt information; and
a controller configured to:
receive a user query corresponding to a task,
determine, by a first large language model (LLM) based component corresponding to a look-ahead planning phase, a shortlisted set of potential actions from a plurality of available actions available based on a current state of an interactive environment,
generate, by a second LLM based component corresponding to an agile navigation phase, a textual reason for selecting an action from the shortlisted set of potential actions,
determine, by the second LLM based component, a single optimal next action from the shortlisted set of potential actions based on the textual reason, and
execute the single optimal next action to transition the interactive environment to a new state.

13. The AI device of claim 12, wherein the controller is further configured to:
iteratively repeat determining the shortlisted set of potential actions, generating the textual reason, determining the single optimal next action, and the executing the single optimal next action until the task is completed.

14. The AI device of claim 13, wherein the controller is further configured to:
terminate actions for the task upon reaching a predefined step limit.

15. The AI device of claim 12, wherein the controller is further configured to:
dynamically select an in-context example chunk from among a plurality of in-context example chunks based on a relevance of the in-context example chunk to the current state of the interactive environment, wherein the in-context example chunk includes a template for a successful interaction including at least an example previous action-observation pair and an example textual reason, and
provide a prompt including the in-context example chunk to the second LLM based component for generating the textual reason.

16. The AI device of claim 12, wherein the controller is further configured to:
dynamically select an in-context example chunk from among a plurality of in-context example chunks based on a relevance of the in-context example chunk to the current state of the interactive environment, wherein the in-context example chunk includes a template for a successful interaction including at least an example previous action-observation pair, the textual reason and an example determined next action, and
provide a prompt including the in-context example chunk to the second LLM based component for determining the single optimal next action.

17. The AI device of claim 12, wherein the controller is further configured to:
analyze, by the first LLM based component, a plurality of action-observation pairs, each of the plurality of action-observation pairs corresponding to one of the plurality of available actions and a corresponding resulting observation in the interactive environment for determining the shortlisted set of potential actions.

18. The AI device of claim 17, wherein the determining the shortlisted set of potential actions is based on a reward model configured to score the potential actions based on a predicted utility for advancing the task.

19. The AI device of claim 12, wherein the textual reason is part of a reasoning trace, the reasoning trace including a textual output from the second LLM based component that articulates a logical justification for selecting the single optimal next action for ensuring the single optimal next action is consistent with a coherent strategy for completing the task.

20. A non-transitory computer readable medium storing computer-executable instructions that when executed by a processor, cause the processor to perform the operations of:
receiving a user query corresponding to a task;
determining, by a first large language model (LLM) based component corresponding to a look-ahead planning phase, a shortlisted set of potential actions from a plurality of available actions available based on a current state of an interactive environment;
generating, by a second LLM based component corresponding to an agile navigation phase, a textual reason for selecting an action from the shortlisted set of potential actions;
determining, by the second LLM based component, a single optimal next action from the shortlisted set of potential actions based on the textual reason; and
executing the single optimal next action to transition the interactive environment to a new state.
